(19) United States
(12) Patent Application Publication
(10) Pub. No.: US 2006/0262709 A1
(43) Pub. Date: Nov. 23, 2006

(54) Optical information recording apparatus, optical information recording method, and signal processing circuit

(76) Inventors: Hiroya Kakimoto, Gunma (JP); Mitsuo Sekiguchi, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/390,934

(22) Filed: Mar. 28, 2006

(30) Foreign Application Priority Data
Mar. 28, 2005 (JP) 2005-092253

(51) Int. Cl. G11B 7/00

(52) U.S. Cl. 369/121

(57) ABSTRACT

There is provided a method which can obtain an optimum recording condition even in case of a medium unknown to a drive, in particular, a recording condition effective for avoiding recording distortion in case of high-speed recording having a difficulty in test recording. An index representing recording quality, for example, a jitter, is acquired by test recording with power values or pulse widths gradually changed, and a recording condition where the change in jitter value is maximum is specified as a condition with recording distortion. For example, in case that the change in jitter value between the power values P1 and P2 shows a maximum change amount Δmax, recording distortion is generated with a power value equal to P1, P2 or more. Therefore, by applying the power value P1 to the upper limit of the recording condition, recording can be performed with no recording distortion.

### BACKGROUND OF THE INVENTION

1. Field of the Invention

The field relates to an optical information recording apparatus, an optical information recording method, and a signal processing circuit. In particular, the present invention relates to an optical information recording apparatus capable of optimizing a recording condition depending on compatibility between a drive and a medium.

2. Description of the Related Technology

In a recording process onto an optical information recording medium (hereinafter, referred to as ‘medium’) as represented by CR-R, DVD-R, or the like, compatibility between a medium to be recorded and a recording apparatus (hereinafter, referred to as ‘drive’) to be used for recording depends on the combination of the drive and the medium. As a cause for the dependence, medium-side factors which affect an optimum recording condition due to a difference in type of a recording material constituting a medium or a manufacturing variation in deposited film properties, and drive-side factors which affect an optimum condition due to a difference in type of an optical pickup device or a semiconductor laser constituting a drive or a manufacturing variation in assemblies may be taken into account. However, the cause is actually due to a certain combination of these factors, and thus there exists an optimum recording condition for every combination of a medium and a drive.

In the past, a method has been employed in such a manner that ID information from which a type of a medium can be identified by a drive is stored to a medium side, and a recording condition prepared for each type of medium is stored to a drive side. According to this method, when actual recording is performed, the ID information on the medium is read from the medium being loaded in the drive and a recording condition (hereinafter, referred to as ‘write strategy’) associated with the ID information is used.

However, sometimes the above-described method cannot accept an unknown medium, which has not been examined, under a prepared recording condition, although it can select to some extent a recording condition appropriate for a known medium, which has been examined. Further, sometimes the above-described method cannot accept even a known medium under a prepared recording condition in case of a change in recording environment such as a recording rate, disturbance, or change with time.

A method intended to accept such an unknown medium is described in Japanese patent publication nos. JP-A-2003-30837 and JP-A-2004-110995. The paragraph [0020] of JP-A-2003-30837 describes ‘ . . . a phase error relative to a channel clock is detected for every recording pattern. A recording compensation parameter adjusting section 12 optimizes a light-emission waveform rule based on the detection result by a phase error detecting section 11 . . . ’. That is, in JP-A-2003-30837, there is disclosed a method which detects a phase error and corrects the phase error through the comparison with the channel clock.

The paragraph [0024] of JP-A-2003-30837 describes ‘A test pattern is then recorded to determine the light-emission waveform rule. Next, the relationship between a prepared light-emission waveform rule and a phase error amount is investigated by reproducing the region onto which the test pattern is recorded. That is, a phase error amount for every combination of a length of one of various marks and a space length immediately before the mark is measured. A desired light-emission waveform rule is then determined by estimating the light-emission waveform rule, under which the phase error becomes zero, from the phase error amount measured . . . ’. That is, there is disclosed a method which measures a phase error amount for every combination of a mark and a corresponding space and then estimates the light-emission waveform rule under which the phase error becomes zero (see FIGS. 8 and 12).

According to the method described in JP-A-2003-30837, the correction is performed based on the phase error of a recorded pattern, and thus it is effective for optimizing a strategy.

However, like the past, the method described in JP-A-2003-30837 involves the fine adjustment of the strategy which is previously stored in a drive. Accordingly, good recording quality is rarely implemented for a medium which is not adaptive to the previously stored strategy.

The paragraph [0045] of JP-2004-110995 describes ‘. . . a top pulse corresponding to a 3T period and a non-multi-pulse corresponding to an 8T period are integrally (successively) generated . . . ’. Further, the paragraph [0046] describes ‘. . . a laser power for a write pulse is adjusted in two stages and, when the ratio of a laser power (a pulse height value of the top pulse) Ph to a laser power (a pulse height value of the non-multi-pulse) Pm is optimum, an optimum power can be obtained . . . ’. That is, it is suggested that an optimization of the ratio Ph/Pm is effective.

However, in the method described in JP-A-2004-110995, initial values for Ph and Pm are temporarily set based on values stored in a drive or a medium, as described in the paragraph [0067] thereof, and then an optimum Ph/Pm ratio is obtained. Therefore, similarly to the case of JP-A-2003-30837, good recording quality is rarely implemented for a medium which is not adaptive to the temporarily set values.

On the other hand, in an optical information recording system, when data recording is performed onto a predetermined recording medium, in general, a recording condition adaptive to the recording medium is obtained by test recording using a test recording region provided in the recording medium, before actual data recording.

However, in an optical information recording system for high-speed recording, it is difficult to perform test recording at the same rate as that of actual recording due to the positional relationship of the test recording region and an actual recording region, and the limitation in rotational speed of a spindle motor for rotating the recording medium.

In the past, there has been generally used a method which previously stores a recording condition adaptive to each recording rate for every kind of recording medium in a recording apparatus for performing data recording, and reads out and sets the recording condition at the time of actual high-speed recording, thereby performing data recording.

In the related technology, the fine adjustment of a recording condition at the time of high-speed recording is also performed by using a different between an optimum recording condition when test recording is performed at a recording rate enabling test recording and an optimum condition stored in the recording apparatus.

However, the related art cannot sufficiently accept a variation in characteristics of a recording medium and a recording system. Further, the related art cannot accept a recording medium, which has not been previously stored in the recording apparatus, or ‘unknown medium’ such as a recording medium, which has been developed after the manufacture of the recording apparatus. Accordingly, a technology has been demanded which obtains an optimum recording condition for every recording rate depending on the characteristics of a medium onto which data recording is performed and a recording apparatus.

As a method for solving the problem, there has been known a method, as described in JP-A-2004-234698, which reads out the relationship between amplitude information of two kinds or more of recording rates previously recorded onto a recording medium and a recording power, and calculates a recording power of a recording rate to be recorded.

However, because this method has an assumption that information for recording power calculation is previously recorded onto a recording medium, the information cannot accept a recording rate, which has not been recorded. Further, the information is recorded during a production step of the recording medium, which causes a reduction in production efficiency and an increase in manufacturing cost due to an increase in production steps. In addition, a countermeasure may be insufficient when recording at a calculated recording power is difficult in a system.

In a high-speed or high-density recording system, a recording distortion is generated due to reproduction interference or thermal interference between marks, which tends to cause signal distortion in a reproduced signal when recorded data is reproduced. Accordingly, there is a problem in that recording quality suddenly deteriorates due to signal distortion. However, in the methods of the above-described documents, a countermeasure against this problem has not been taken into account. Accordingly, a stable recording environment is rarely provided due to the occurrence of signal distortion.

### SUMMARY OF CERTAIN INVENTIVE ASPECTS

Accordingly, it is an object of certain inventive aspects to provide a method of optimizing a recording condition depending on compatibility between a drive and a medium. It is another object of certain inventive aspects to provide a method which is available for obtaining an appropriate recording condition even in case of high-speed recording where test recording is difficult, and a method which is available for setting an optimum recording condition preventing the occurrence of signal distortion in case of CAV (constant angular velocity) or CLV (constant linear velocity) recording where a recording rate changes from an inner circumference toward an outer circumference.

In order to achieve the above-described objects, according to a first aspect of the invention, an optical information recording apparatus for recording information onto an optical recording medium by irradiating laser light based on a recording pulse includes means for generating signal distortion in a test region of the medium by test recording onto the medium, means for specifying a recording condition with the signal distortion generated, and means for setting conditions of the recording pulse with a condition corresponding to the set recording condition as an upper limit.

As such, by setting the recording condition with the signal distortion generated using test recording, high-quality recording can be performed with no distortion. Moreover, the signal distortion means a state where distortion is generated in a reproduced signal due to a factor leading to a change by recording distortion, other than deformation of a pregroove constituting the medium or the like even when a pit is formed in a desired shape as well as when the shape of a pit is distorted due to known thermal interference or the like.

Moreover, the condition corresponding to the specified recording condition serving as the upper limit includes giving a margin in a certain range relative to a distortion generation condition.

According to a second aspect of the invention, an optical information recording apparatus for recording information onto an optical recording medium by irradiating laser light based on a recording pulse includes means for performing test recording onto the medium while gradually changing the conditions of the recording pulse, means for acquiring recording characteristics obtained by reproducing the result of test recording for every condition gradually changed, means for detecting change amounts in recording characteristics according to the change of the condition, means for specifying a maximum value of the detected change amounts and specifying a condition corresponding to the maximum value, and means for setting the conditions of the recording pulse with the condition corresponding to the specified condition as an upper limit.

As such, by specifying a region where the change in recording characteristic is the maximum, the generation region of the signal distortion can be suitably specified.

According to a third aspect of the invention, an optical information recording apparatus for recording information onto an optical recording medium by irradiating laser light based on a recording pulse includes means for performing test recording in a test region provided on an inner circumference side of the medium at a first rate, means for determining a power of the recording pulse at the first rate based on the result of test recording, means for determining a power of the recording pulse at a second rate higher than the first rate by using the determined power at the first rate, means for detecting signal distortion generated within the test region, means for specifying a power with which the detected signal distortion is generated, means for specifying a distortion generating power at the second rate by using the specified distortion generating power, and means for reducing the power of the recording pulse and/or increasing a duty in case that the determined power at the second rate is more than a power corresponding to the distortion generating power at the second rate.

Moreover, the power corresponding to the distortion generating power serving as the upper limit of the power includes a power having a margin in a certain range relative to the distortion generating power.

As such, by specifying the power with which the signal distortion is generated, and setting the recording condition with the condition corresponding to the power as the upper limit, high-quality recording can be performed with no distortion. For example, when the power is more than the upper limit, by increasing the duty, the amount of required energy can be ensured in a state where the increase in power is restricted. Therefore, even when the power already reaches the upper limit, a recording rate can be improved.

According to a fourth aspect of the invention, the optical information recording apparatus according to the third aspect of the invention may further include means for reducing a recording rate in case that the power of the recording pulse is more than the power corresponding to the distortion generating power even when the reduction in power and/or the increase in duty are performed.

As such, in case that only the reduction in power or the increase in duty is insufficient, by reducing the recording rate, high-speed recording can be maintained without drastically reducing the recording rate.

According to a fifth aspect of the invention, an optical information recording apparatus for recording information onto an optical recording medium by irradiating laser light based on a recording pulse includes means for performing test recording in a test region provided on an inner circumference side of the medium at a first rate, means for determining a duty of the recording pulse at the first rate based on the result of test recording, means for determining a duty of the recording pulse at a second rate higher than the first rate by using the determined duty at the first rate, means for detecting the signal distortion generated within the test region, means for specifying a duty with which the detected signal distortion is generated, means for specifying a distortion generating duty at the second rate by using the specified distortion generating duty, and means for reducing the power of the recording pulse and/or increasing a duty in case that the determined duty at the second rate is more than a duty corresponding to the distortion generating duty at the second rate.

As such, by specifying the duty with which the signal distortion is generated, and setting the recording condition with the duty corresponding to the specified duty as the upper limit, high-quality recording can be performed with no distortion. For example, when the duty is more than the upper limit, by reducing the power, the amount of required energy can be ensured in a state where the increase in duty is restricted. Therefore, even when the duty already reaches the upper limit, a recording rate can be improved.

Moreover, the duty corresponding to the distortion generating duty serving as the upper limit of the duty includes a duty having a margin in a certain range relative to the distortion generating duty.

Further, according to a sixth aspect of the invention, the optical information recording apparatus according to the fifth aspect of the invention may further include means for reducing a recording rate in case that the duty of the recording pulse is more than the duty corresponding to the distortion generating duty even when the reduction in power and/or the increase in duty are performed.

As such, in case that only the reduction in power or the increase in duty is insufficient, by reducing the recording rate, high-speed recording can be maintained without drastically reducing the recording rate.

According to a seventh aspect of the invention, an optical information recording apparatus for recording information onto an optical recording medium by irradiating laser light based on a recording pulse includes means for performing test recording in a test region provided on an inner circumference side of the medium at a first rate, means for determining a condition of the recording pulse at the first rate based on the result of test recording, means for determining a condition of the recording pulse at the second rate higher than the first rate by using the determined condition at the first rate, means for detecting the signal distortion generated within the test region, means for specifying a condition with which the detected signal distortion is generated, means for obtaining the relationship between the specified distortion generation condition and the determined condition at the first rate, means for specifying a distortion generation condition at the second rate by using the obtained relationship, and means for performing recording in a recording region provided on an outer circumference side from the test region at the second rate.

As such, the distortion generation condition for the rate capable of test recording is specified, and the distortion generation condition at the rate having a difficulty in test recording is specified by using the specified distortion generation condition. Therefore, in case of high-speed recording, high-quality recording can be also performed with no distortion.

In addition, the recording condition appropriate to each recording rate is obtained by test recording before actual data recording. Therefore, a medium or a drive which does not have information for the determination of a recording condition in advance can be accepted. As a result, a variation in characteristic of a medium or a drive can be absorbed, thereby improving stability of a system or productivity of a medium or a drive.

According to an eighth aspect of the invention, an optical information recording apparatus for recording information onto an optical recording medium by irradiating laser light based on a recording pulse includes means for performing test recording in a test region provided on an inner circumference side of the medium at a first rate, means for determining a condition of the recording pulse at the first rate based on the result of test recording, means for determining a condition of the recording pulse at a second rate higher than the first rate by using the determined condition at the first rate, means for detecting signal distortion within the test region, means for specifying a condition with which the detected signal distortion is generated, means for specifying a distortion generation condition at the second rate by using the specified distortion generation condition, means for judging whether or not recording can be performed in the recording region provided on the outer circumference side from the test region at the second rate with no distortion, by using the determined distortion generation condition at the second rate, means for changing a recording rate based on the judgment result, and means for reporting a recording rate after the judgment.

As such, by reporting the recording rate after the judgment, a user can know the limit value of the recording rate depending on the combination of a medium and a drive. When more high-speed and high-quality recording is desired, an index for selecting a high-sensitive medium fit to the drive can be provided.

The report of the recording rate is performed by a method which clearly states a recordable rate depending on the combination of a medium and a drive or a rate after the recording rate is reduced, by use of monitor display or the like.

According to a ninth aspect of the invention, an optical information recording apparatus for recording information onto an optical recording medium by irradiating laser light based on a recording pulse includes means for performing test recording in a test region provided on an inner circumference side of the medium at a first rate, means for determining a condition of the recording pulse at the first rate based on the result of test recording, means for determining a condition of the recording pulse at a second rate higher than the first rate by using the determined condition at the first rate, means for detecting signal distortion within the test region, means for specifying a condition with which the detected signal distortion is generated, means for specifying a distortion generation condition at the second rate by using the specified distortion generation condition, means for judging whether or not recording can be performed in the recording region provided on the outer circumference side from the test region at the second rate with no distortion, by using the determined distortion generation condition at the second rate, means for changing a recording rate based on the judgment result, and means for storing a recording condition after the judgment. In this case, the determination of the recording pulse condition at the second rate is performed by using the stored recording condition.

As such, by storing a high-speed recording condition obtained from a low-speed recording condition through the prediction in a memory of the drive, or the test region or the recording region of the medium, the prediction of a recording power at the time of next high-speed recording can be efficiently performed.

Here, the recording condition after the judgment to be stored includes the condition of the recording pulse, the distortion generation condition, other characteristics or relational expressions obtained from test recording, and the judgment results.

According to a tenth aspect of the invention, an optical information recording method for recording information onto an optical recording medium by irradiating laser light based on a recording pulse includes generating signal distortion in a test region of the medium by test recording onto the medium, specifying a recording condition with which the signal distortion is generated, and setting a condition of the recording pulse with a condition as corresponding to the specified recording condition as an upper limit.

According to an eleventh aspect of the invention, an optical information recording method for recording information onto an optical recording medium by irradiating laser light based on a recording pulse includes performing test recording onto the medium while gradually changing the condition of the recording pulse, acquiring recording characteristics obtained by reproducing the result of test recording for every condition gradually changed, detecting change amounts in recording characteristics according to the change of the condition, specifying a maximum value of the detected change amounts and specifying a condition corresponding to the maximum value, and setting a condition of the recording pulse with a condition as corresponding to the specified condition as an upper limit.

According to a twelfth aspect of the invention, an optical information recording method for recording information onto an optical recording medium by irradiating laser light based on a recording pulse includes performing test recording at a first rate in a test region provided on an inner circumference side of the medium, determining a power of the recording pulse at the first rate based on the result of test recording, determining a power of the recording pulse at a second rate higher than the first rate by using the determined power at the first rate, detecting signal distortion generated within the test region, specifying a power with which the detected signal distortion is generated, specifying a distortion generating power at the second rate by using the specified distortion generating power, and reducing the power of the recording pulse and/or increasing a duty in case that the determined power at the second rate is more than a power corresponding to the distortion generating power at the second rate.

According to a thirteenth aspect of the invention, an optical information recording method for recording information onto an optical recording medium by irradiating laser light based on a recording pulse includes performing test recording at a first rate in a test region provided on an inner circumference side of the medium, determining a duty of the recording pulse at the first rate based on the result of test recording, determining a duty of the recording pulse at the second rate higher than the first rate by using the determined duty at the first rate, detecting the signal distortion generated within the test region, specifying a duty with which the detected signal distortion is generated, specifying a distortion generating duty at the second rate by using the specified distortion generating duty, and reducing the power of the recording pulse and/or increasing a duty in case that the determined duty at the second rate is more than a duty corresponding to the distortion generating duty at the second rate.

According to a fourteenth aspect of the invention, an optical information recording method for recording information onto an optical recording medium by irradiating laser light based on a recording pulse includes performing test recording at a first rate in a test region provided on an inner circumference side of the medium, determining a condition of the recording pulse at the first rate based on the result of test recording, determining a condition of the recording pulse at the second rate higher than the first rate by using the determined condition at the first rate, detecting the signal distortion generated within the test region, specifying a condition with which the detected signal distortion is generated, obtaining the relationship between the specified distortion generation condition and the determined condition at the first rate, specifying a distortion generation condition at the second rate by using the obtained relationship, and performing recording in a recording region provided on an outer circumference side from the test region at the second rate.

According to a fifteenth aspect of the invention, an optical information recording method for recording information onto an optical recording medium by irradiating laser light based on a recording pulse includes performing test recording at a first rate in a test region provided on an inner circumference side of the medium, determining a condition of the recording pulse at the first rate based on the result of test recording, determining a condition of the recording pulse at the second rate higher than the first rate by using the determined condition at the first rate, detecting the signal distortion generated within the test region, specifying a distortion generation condition with which the detected signal distortion is generated, specifying a distortion generation condition at the second rate by using the specified distortion generation condition, judging whether or not recording can be performed in the recording region provided on the outer circumference side from the test region at the second rate with no distortion, by using the determined distortion generation condition at the second rate, changing a recording rate based on the judgment result, and reporting a recording rate after the judgment.

According to a sixteenth aspect of the invention, an optical information recording method for recording information onto an optical recording medium by irradiating laser light based on a recording pulse includes performing test recording at a first rate in a test region provided on an inner circumference side of the medium, determining a condition of the recording pulse at the first rate based on the result of test recording, determining a condition of the recording pulse at the second rate higher than the first rate by using the determined condition at the first rate, detecting the signal distortion generated within the test region, specifying a distortion generation condition with which the detected signal distortion is generated, specifying a distortion generation condition at the second rate by using the specified distortion generation condition, judging whether or not recording can be performed in the recording region provided on the outer circumference side from the test region at the second rate with no distortion, by using the determined distortion generation condition at the second rate, changing a recording rate based on the judgment result, and storing a recording condition after the judgment. In this case, the determination of the recording pulse condition at the second rate is performed by using the stored recording condition.

According to a seventeenth aspect of the invention, there is provided a signal processing circuit incorporated into an optical information recording apparatus configured to irradiate laser light based on a recording pulse for recording information onto an optical information medium at multiple rates, and configured by the optical information recording method according to any one of the tenth to sixteenth aspects.

Preferably, in certain aspects of the invention, there is provided a method for detecting the generation condition of ‘signal distortion’ by test recording to be performed before actual data recording. Further, there is also provided a method for predicting the generation condition of ‘signal distortion’ at the time of speed recording assigned with the generation condition of ‘signal distortion’ at the time of test recording at a recordable recording rate in case that an assigned recording rate is a condition having a difficulty in test recording. And then, the optimum recording PW and the optimum pulse condition in consideration with the generation condition of ‘signal distortion’ are determined as the optimum recording condition, thereby providing a stable recording and reproducing system.

Here, in certain aspects of the invention, the determination of the recording power at each recording rate is preferably performed such that a predetermined estimation parameter when data which was actually recorded at each recording rate is reproduced becomes a predetermined value or is in a predetermined range.

The predetermined estimation parameter includes an estimation index using amplitude information such as a β value, an asymmetry value, or a modulation index of the reproduced signal, or an estimation index using time or length information such as a jitter value or an error rate of the reproduced signal.

The predetermined value or the predetermined range includes a target level derived from the result of test recording performed before data recording or a target level previously set for each recording rate.

A condition of high-speed recording to be performed on the inner circumference side is calculated by using the condition obtained by low-speed recording performed on the inner circumference side, which results in obtaining a recording condition for a rate at which recording cannot be performed on the inner circumference side. This effect markedly appears when a rate at which recording can be performed in the test region is a first rate and a rate at which recording cannot be performed in the test region is a second rate.

Further, by using the change in characteristic of the result of test recording by at least two rates, a high-speed recording condition under which test recording can be performed with difficulty can be predicted from a low-speed recording condition capable of test recording. Moreover, a rate to be used for test recording preferably includes an allowable maximum rate in the test region.

Further, the relationship between the power and the duty for a rate capable of test recording is obtained, and the power or duty for a rate having a difficulty in test recording is temporarily set. Then, by using the relationship between the power and the duty, a power or a duty for a rate having a difficulty in test recording is obtained. Therefore, a high-speed recording condition having a difficulty in test recording can be predicted from a low-speed recording condition capable of test recording.

Here, a method for deriving the relationship between the power and the duty may derive the relationship by test recording, may read out a previously stored value, or may derive the relationship by the previously stored value and test recording.

The relationship between the power and the duty is preferably calculated as an expression or a coefficient. Further, a duty condition for each recording rate may be fixed to the maximum value derived with the recording rate condition capable of test recording or may be changed for every recording rate.

A change in duty of the recording pulse may be performed by changing the entire length of the recording pulse having a top pulse and a following pulse, may be performed by changing only the length of the top pulse, or may be performed by changing only the length of the following pulse.

Recording quality of a maximum density pulse having a high appearance frequency at which recording is extremely performed can be improved by changing the top pulse as an example of the change in duty. Therefore, an optimum recording environment can be provided.

Further, for the detection of the signal distortion, preferably, recording is performed with at least two recording conditions, and signal quality when recorded data is reproduced is used as an estimation parameter. As the estimation parameter, a jitter, an error rate, length information of one or plural mark data, or amplitude information of one or plural mark data when recorded data is reproduced can be used.

As a recording pattern to be used for test recording when detecting the signal distortion, a predetermined specific pattern or a random pattern can be used.

When predicting the generation condition of the signal distortion, from a predetermined prediction expression by using the distortion generation condition detected through test recording at a predetermined recording rate, a distortion generation condition in case of a recording rate different from the predetermined recording rate can be predicted. Here, the predetermined prediction expression can include a prediction function stored in a drive in advance, a prediction function stored in a medium, and a prediction function obtained when test recording.

In certain aspects of the invention, the recording pulse preferably has a top pulse and a following pulse. The top pulse is configured to correspond to the shortest pit that has the highest appearance frequency and the difficulty in recording. For example, in either case of a pit train having 3T to 11T for CD-R or a pit train having 3T to 11T and 14T for DVD-R, the top pulse preferably corresponds to the 3T pit. In either case of marks 2T to 8T for a Blue-ray system or marks 2T to 8T for an HD-DVD system, the top pulse preferably corresponds to the 2T mark.

Further, the following pulse can be configured to be a non-multi-pulse or a multi-phase. In case of a non-multi-pulse, a recording pulse is preferably optimized based on a power ratio of the top pulse to the following pulse. In case of a multi-pulse, a recording pulse is preferably optimized by adjusting a duty of each of a plurality of divided pulses constituting the following pulse.

Conditions of the top and following pulses may be determined in any combination of a pulse power, a pulse width, and a duty. Preferably, a recording pulse is optimized by adjusting a ratio of the top pulse to the following pulse.

The determination of the following pulse after the determination of the top pulse allows the realization of more stable recording quality. That is, the determination of an optimum top pulse condition is first performed, which results in finding the optimum top pulse condition. And then, a following pulse condition is determined. In contrast, as described in JP-2004-110995, the optimization of the ratio of the top pulse to the following pulse is preferentially performed, which leads to the reduction in accommodation capability for a medium unknown to a drive because sometimes an optimum solution for the top pulse is not obtained. Moreover, in order to improve accuracy, the determination of the top pulse condition followed by the determination of the following pulse condition may be repeated several times.

As described above, according to certain inventive aspects, in case of a medium unknown to a drive, a recording condition closer to an optimum can be obtained. In particular, in case of high-speed recording having a difficulty in test recording, a recording condition effective for avoiding signal distortion can be obtained.

### BRIEF DESCRIPTION OF THE DRAWINGS

FIGS. 1A and 1B are conceptual diagrams showing the configuration of a recording pulse and an overall flow for determining a recording condition according to an embodiment of the invention;

FIG. 2 is a block diagram showing the internal configuration of a drive according to an embodiment of the invention;

FIG. 3 is a flow chart showing a detailed execution procedure of an m′T determination flow shown in FIG. 1;

FIG. 4 is a flow chart showing the details of a step of determining a reference threshold shown in FIG. 3;

FIG. 5 is a conceptual diagram showing an example of the flow shown in FIG. 4;

FIG. 6 is a conceptual diagram showing an example of the flow shown in FIG. 4;

FIG. 7 is a conceptual diagram showing an example of a case where a threshold is calculated for each drive;

FIGS. 8A and 8B are conceptual diagrams showing an example of downwardly convex patterns obtained as a result of the inspection of recording quality executed at the step S120 in FIG. 3;

FIGS. 9A and 9B are conceptual diagrams showing an example of downward-sloping patterns obtained as a result of the inspection of recording quality executed at the step S120 in FIG. 3;

FIGS. 10A and 10B are conceptual diagrams showing an example of upward-sloping patterns obtained as a result of the inspection of recording quality executed at the step S120 in FIG. 2;

FIG. 11 is a conceptual diagram showing an example of the determination of a test region to be executed at the step S122 in case of the downwardly convex patterns obtained at the step S120 in FIG. 3;

FIG. 12 is a conceptual diagram showing an example of the determination of a test region to be executed at the step S122 in case of the downward-sloping patterns obtained at the step S120 in FIG. 2;

FIG. 13 is a conceptual diagram showing an example of the determination of a test region to be executed at the step S122 in case of the upward-sloping patterns obtained at the step S120 in FIG. 3;

FIG. 14 is a diagram showing an example of a case where the step 120 in FIG. 3 is executed by using eight patterns;

FIG. 15 is a conceptual diagram illustrating a method for the determination of a power range to be used at the step S122 in FIG. 3 by curve approximation;

FIG. 16 is a conceptual diagram illustrating another example of the determination of a power range to be used at the step S122 in FIG. 3 by curve approximation;

FIG. 17 is a conceptual diagram illustrating an example of the determination of a power range to be used at the step S122 in FIG. 3 by sampling;

FIGS. 18A and 18B are conceptual diagrams showing an example of a recording pulse to be used for test recording for the determination of a ratio at the step 200 shown in FIG. 1B;

FIG. 19 is a flow chart showing an execution procedure of a ratio determination flow at the step S200 shown in FIG. 1B;

FIG. 20 is a conceptual diagram showing an operation concept from test recording to the count of reproduced data shown in FIG. 19;

FIG. 21 is a conceptual diagram showing the storage of count results shown in FIG. 19;

FIGS. 22A and 22B are conceptual diagrams showing a histogram preparation shown in FIG. 19;

FIGS. 23A and 23B are conceptual diagrams showing the determinations of thresholds shown in FIG. 19;

FIGS. 24A and 24B are conceptual diagrams showing an example of the thresholds obtained by the method shown in FIGS. 23A and 23B;

FIG. 25 is a diagram showing an example of a recording pattern to detect a shift amount due to a pit balance;

FIG. 26 is a conceptual diagram showing the configuration of a table for searching specific patterns to be used for the detection of the shift due to a pit balance;

FIG. 27 is a conceptual diagram showing a specific example of a case where a shift length is detected by the absolute comparison of count results;

FIG. 28 is a flow chart showing an execution example of the prediction of a control amount shown in FIG. 19;

FIG. 29 is a conceptual diagram showing the relationship between the change in recording condition S1 to S2 and the shift amount D1 to D2 when changing PWD;

FIG. 30 is a conceptual diagram showing an example of a shift length correction using a linear approximation in case of a single pulse;

FIG. 31 is a conceptual diagram showing an example of a shift length correction using a linear approximation in case of a multi-pulse;

FIG. 32 is a conceptual diagram showing the configuration of a table for storing correction amounts PWD and Tmp;

FIG. 33 is a conceptual diagram showing a configuration concept of an nT pulse to be executed at the step S300 in FIG. 1B;

FIGS. 34A and 34B are conceptual diagrams showing an example of a test recording pulse to be used for a phase shift correction at the step S400 shown in FIG. 1B;

FIG. 35 is a flow chart showing an execution procedure of a phase condition determination flow at the step S400 shown in FIG. 1B;

FIG. 36 is a conceptual diagram showing an example of a recording pattern to detect a phase shift amount on the front side of each pit length;

FIG. 37 is a conceptual diagram showing an example of a recording pattern to detect a phase shift amount on the rear side of each pit length;

FIG. 38 is a conceptual diagram illustrating an example of a recording pattern to detect a shift length of each pit due to thermal interference;

FIGS. 39A and 39B are conceptual diagrams showing the configuration of a table for searching specific patterns to be used for the detection of a phase shift on the front side of a pit and for the detection of a phase shift on the rear side of a pit;

FIG. 40 is a conceptual diagram showing the configuration of a table for searching specific patterns to be used for detecting a pit interference shift;

FIG. 41 is a conceptual diagram showing a specific example of a case where a shift amount is detected by the relative comparison of count results;

FIG. 42 is a flow chart showing an execution procedure of the determination of Ttopr and Tlast by the prediction of a control amount shown in FIG. 35;

FIG. 43 is a conceptual diagram showing the relationship between the change in recording condition S1 to S2 and the shift amount D1 to D2;

FIG. 44 is a conceptual diagram showing an example of the correction for a phase shift on the front side of a pit using a linear approximation;

FIG. 45 is a conceptual diagram showing an example of the correction for a phase shift on the rear side of a pit using a linear approximation;

FIGS. 46A and 46B are conceptual diagrams showing the configuration of a table for storing correction amounts Ttop and Tlast;

FIG. 47 is a conceptual diagram showing an example of single pulses after corrections;

FIG. 48 is a conceptual diagram showing an example of multi-pulses after corrections;

FIG. 49 is a conceptual diagram showing the relationship between inner and outer circumferences of a medium and an executable recording rate;

FIGS. 50A and 50B are conceptual diagrams showing an example of the configuration when the recording pulses shown in FIGS. 18A and 18B are applied to high-speed recording;

FIGS. 51A and 51B are conceptual diagrams showing a concept for obtaining a duty defined by a power and a length of a top pulse in case of high-speed recording having a difficulty in test recording, by using a power and a duty obtained with low-speed recording where test recording can be performed;

FIGS. 52A and 52B are conceptual diagrams showing a concept for obtaining a duty defined by a power and a length of a recording pulse in case of high-speed recording having a difficulty in test recording, by using a power and a duty obtained with low-speed recording where test recording can be performed;

FIGS. 53A and 53B are conceptual diagrams showing a first method for predicting a power and a duty in case of a rate having a difficulty in test recording, from conditions of a power and a duty obtained by test recording;

FIGS. 54A and 54B are conceptual diagrams showing a second method for predicting a power and a duty in case of a rate having a difficulty in test recording, from conditions of a power and a duty obtained by test recording;

FIG. 55 is a flow chart showing a first execution procedure for predicting a power and a duty for a rate having a difficulty in test recording, from conditions of a power and a duty obtained by test recording;

FIG. 56 is a data diagram showing an execution example of the step S500 shown in FIG. 55;

FIG. 57 is a data diagram showing an execution example of the step S502 shown in FIG. 55;

FIG. 58 is a data diagram showing an execution example of the steps S504 and S506 shown in FIG. 55;

FIG. 59 is a flow chart showing a second execution procedure for predicting a power and a duty for a rate having a difficulty in test recording, from conditions of a power and a duty obtained by test recording;

FIG. 60 is a flow chart showing a third execution procedure for predicting a power and a duty for a rate having a difficulty in test recording, from conditions of a power and a duty obtained by test recording;

FIG. 61 is a data diagram showing an execution example of the steps S622 and S624 shown in FIG. 60;

FIGS. 62A and 62B are conceptual diagrams showing the relationship between an upper limit of a recording power and a margin;

FIG. 63 is a conceptual diagram showing the relationship between a recording power and a duty;

FIG. 64 is a conceptual diagram showing a state of an RF signal when recording distortion is generated;

FIG. 65 is a conceptual diagram showing an example of a method for detecting the recording distortion;

FIG. 66 is a conceptual diagram showing an example of the determination of a recording condition in consideration of the recording distortion;

FIG. 67 is a conceptual diagram showing an example of a method for predicting a condition where recording distortion is generated; and

FIGS. 68A and 68B are conceptual diagrams showing a method for determining a recording condition with no distortion.

### DESCRIPTION OF CERTAIN INVENTIVE EMBODIMENTS

An optical information recording apparatus according to certain inventive aspects will now be described in detail with reference to the accompanying drawings. Moreover, the invention may be modified from time to time, and shall not be limited to the embodiments described herein.

FIGS. 1A and 1B are conceptual diagrams showing the configuration of a recording pulse and an overall flow for determining a recording condition according to one embodiment, respectively. As shown in FIG. 1A, the recording pulse 10 has a top pulse 12 located at the forefront of the recording pulse and a following pulse 14 following the top pulse.

When a length of the recording pulse is n′T, the top pulse 12 has a length of m′T, and the following pulse 14 has a length of (n−m)T, where m and n in this embodiment have the values of m=3 and n=3 to 11 or 14, respectively, and T is a unit time defined in an optical disc system, a frequency of which is determined by a clock signal.

A condition of the recording pulse 10 is determined by executing the flow shown in FIG. 1B. The flow is executed with test recording under the condition that an optical information recording medium (hereinafter, referred to as ‘medium’ or ‘disc’) is loaded in an optical information recording apparatus (hereinafter, referred to as ‘recording apparatus’ or ‘drive’).

As shown in FIG. 1B, in case of determining a condition of the recording pulse 10, a pulse condition for the length of m′T is first determined (Step S100) and then the ratio of the pulse condition for the length m′T to the pulse condition for the length (n−m)T, that is, m′T/(n−m)T, is obtained by using the condition for the length m′T (Step S200). Subsequently, an nT pulse is formed based on the ratio (Step S300), and finally the condition of the recording pulse having the length of n′T is determined by correcting for a phase shift (Step S400).

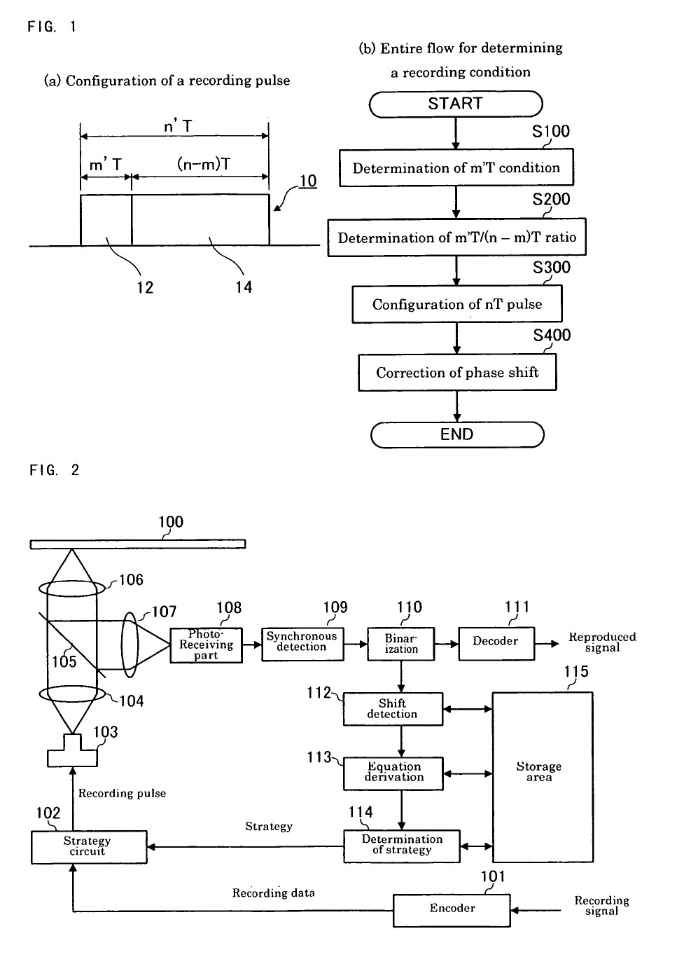

FIG. 2 is a block diagram showing the internal configuration of a drive according to one embodiment. As shown in FIG. 2, the drive 100 records/reproduces information onto/from a medium 50 by using a laser beam emitted from a laser oscillator 103.

When the information is recorded onto the medium 50, a recording signal corresponding to desired recording information is encoded in an EFM format by an encoder 101 and then encoded recording data is transmitted to a strategy circuit 102.

The strategy circuit 102 involves various setting parameters set for a predetermined strategy. The strategy circuit 102 generates a recording pulse that is expected to result in a desired recording state by controlling intensity or a pulse width of the laser beam emitted from the laser oscillator 103 through the correction of various setting parameters for the strategy.

The recording pulse formed by the strategy circuit 102 is transmitted to the laser oscillator 103, which controls an output laser beam in accordance with the recording pulse and irradiates the controlled laser beam onto the medium 50 rotating at a constant linear or rotational velocity through a lens 104, a half mirror 105, and a lens 106, whereby a recorded pattern having a pit/land train corresponding to desired recording data is recorded onto the medium 50.

On the other hand, when the information recorded onto the medium 50 is reproduced, a homogeneous reproducing laser beam emitted from the laser oscillator 103 is irradiated onto the medium 50 rotating at a constant linear or rotational velocity through the lens 104, the half mirror 105, and the lens 106.

The reproducing laser beam, which has less intensity than the laser beam emitted from the laser oscillator 103 during recording, is reflected at the medium 50, and the reflected laser beam from the medium 50 is received by a photo-receiving part 108 through the lens 106, the half mirror 105, and a lens 107, and then is converted into an electrical signal.

The electrical signal output from the photo-receiving part 108 corresponds to a recorded pattern having pits and lands recorded onto the medium 50. The electrical signal output from the photo-receiving part 108 is also used for extracting a clock signal with a predetermined frequency from a wobble component included in the electrical signal by a synchronizing signal detection circuit 109. The electrical signal is further binarized by a binarization circuit 110, then is decoded by a decoder 111, and is finally output as a reproduced signal.

As described above, recording quality in a recording system having a drive and a medium depends on a variation in characteristics of the drive and the medium. Accordingly, absorbing the influence of the dependence with the strategy allows the improvement of the recording quality. In addition, any of various optical information recording mediums including a dye-based medium represented by CD-R or DVD-R and a phase-change medium represented by CD-RW or DVD-RW can be applied to one embodiment.

The flow for determining a recording pulse condition to be executed by the drive described above, shown in FIG. 1B, will now be described in detail.

Determination of m′T Condition

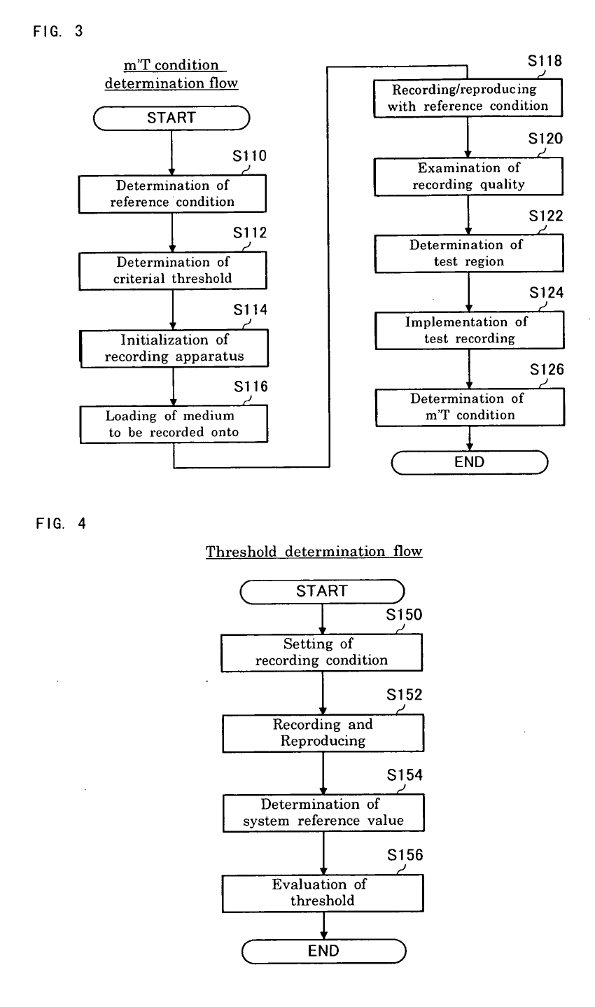

FIG. 3 is a flow chart showing a detailed execution procedure of an m′T condition determination flow shown in FIG. 1B. As shown in FIG. 3, the steps S110 to S114 for initial setting for the drive, the steps S116 to S122 for the determination of a test recording condition, and the step S124 for test recording under the determined test recording condition are sequentially executed by the drive 100. Subsequently, based on the result of test recording, the step S126 for the determination of the m′T pulse condition is executed. The respective steps will now be described in detail.

Determination of Reference Condition

At the step S110 shown in FIG. 3, one pulse width and three power values are first obtained as a reference condition by test recording with a given standard medium while varying a recording rate. Preferably, a value which minimizes a jitter and two other values before and after the value are employed for the three power values based on the result of test recording. Further, for the two other values, values in the vicinity of a threshold to be used as a reference for judging whether or not the jitter is acceptable are preferably employed. The reference condition obtained in such a manner is utilized for the inspection of recording quality to be executed at a subsequent step.

Determining of Reference Threshold

As will be described below, because one embodiment is intended to set a region below the jitter threshold as a range for the test recording condition (hereinafter, referred to as ‘test region’), the threshold serving as the judgment reference needs to be determined. A standard value depending on the kinds of a drive or a medium may be prepared for the threshold. The threshold representing a minimum line of a jitter allowable region varies depending on conditions of optical components and other elements constituting a pickup device shown in FIG. 2 as well as on a recording rate.

Accordingly, it is recommended to set a more accurate test region by obtaining the threshold for every combination of a drive and a medium to be actually used and then giving a more accurate judgment reference.

However, setting the threshold for every combination of a drive and a medium results in the increase in the number of recording processes. Accordingly, the threshold appropriate to each drive may be stored in a storage region 115 during drive manufacturing, assuming that the variation in characteristics between respective drives is a major factor in the variation in threshold.

FIG. 4 is a flow chart showing the details of a step of determining the reference threshold shown in FIG. 3. As shown in FIG. 4, the determination of the reference threshold is executed by executing recording/reproducing under predetermined conditions, determining a reference value for a system based on the recording/reproducing result, and setting a value with a predetermined margin for the reference value to the threshold to be used for the determination of the test region. The respective steps will now be described in sequence.

First, the step S150 for setting a recording condition is executed. At this step, predetermined patterns of conditions necessary for recording/reproducing, including a pulse width, power, a recording/reproducing rate, a recording address, and the like, are prepared. After the recording conditions are set to a drive, a reference medium is loaded in the drive. Preferably, as the reference medium, a medium with standard characteristics is selected from various mediums.

Next, by executing the step S152 for recording and reproducing the loaded reference medium under the recording condition set at the step S150, recording/reproducing characteristic values, such as jitters, are acquired under the respective recording conditions. As the characteristic values to be acquired at this step, values representing recording quality are selected.

Subsequently, the best value, such as a minimum jitter value, is obtained from the recording/reproducing characteristic values acquired at the step S152, and then the step S154 is executed with the best value as a system reference value. Accordingly, a jitter value deemed to be close to an optimum value for the drive is set as the reference value. Moreover, the reference value may be an intermediate value between two points at which a curve approximated for the jitters crosses a predetermined threshold, that is, an intermediate value of a power margin, instead of the optimum jitter value.

Finally, the step S156 is executed for calculating the threshold by multiplying the system reference value determined at the step S154 by a predetermined coefficient α (preferably α>1). Accordingly, the judgment is performed by using the system reference value including the predetermined margin. That is, the threshold can be calculated using the system reference value based on the expression Threshold=(System reference value)×α, where the value of the coefficient α is preferably about 1.5. Moreover, the coefficient α may have an appropriate value depending on a kind of a drive or a medium. For example, a value in a range of α=0.8 to 1.2 may be set so that the threshold is close to the system reference value, or alternatively, a larger value in a range of α=2.0 to 3.0 may be set.

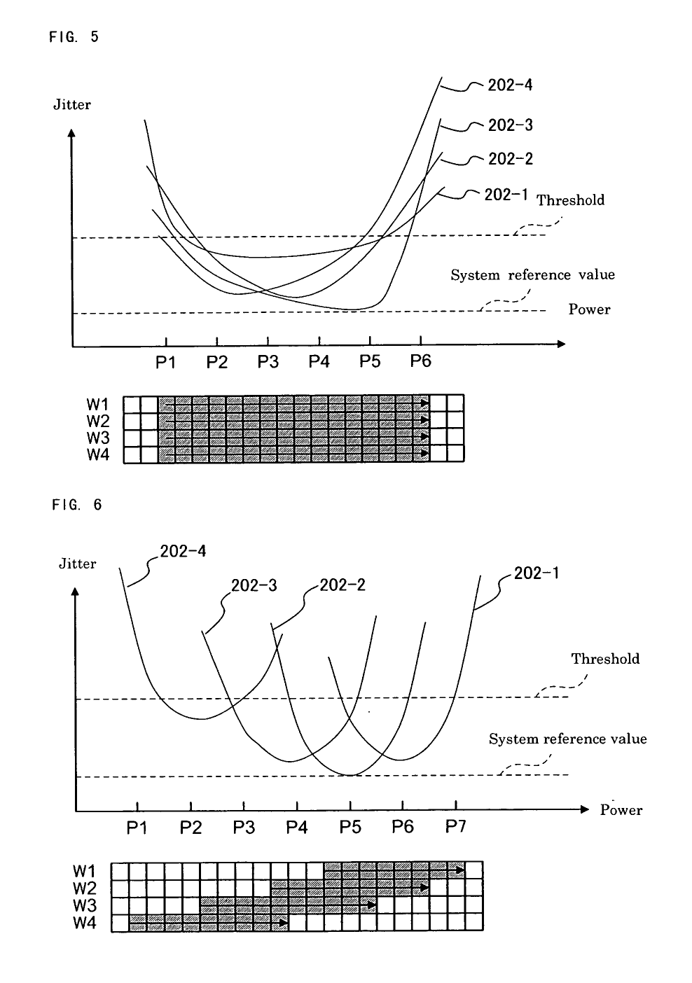

FIG. 5 is a conceptual diagram showing one example of the flow shown in FIG. 4. The example shown in FIG. 5 shows reproduction characteristics 202-1 to 202-4 obtained while changing a power from P1 to P6 for each of pulse widths W1 to W4, in the case where the jitter value is used as the characteristic value representing recording quality. In the example shown in FIG. 5, the pulse widths W1 to W4 and the power values P1 to P6 represent the recording conditions, and a jitter value corresponding to a minimum point of the reproduction characteristic 202-3 showing the lowest jitter value among the four reproduction characteristics is used as the system reference value. The threshold is then obtained by multiplying the system reference value by, for example, 1.5. Moreover, arrows shown in a matrix of FIG. 5 represent directions of change in recording condition and are to be used in the same sense in the following description.

FIG. 6 is a conceptual diagram showing another example of the flow shown in FIG. 4. The example shown in FIG. 6 shows reproduction characteristics 202-1 to 202-4 obtained while changing a power range for each of pulse widths W1 to W4, in the case where the jitter value is used as the characteristic value representing recording quality. In the example shown in FIG. 6, a jitter value corresponding to a minimum point of the reproduction characteristic 202-2 showing the lowest jitter value among the four reproduction characteristics is used as the system reference value, and a threshold is then obtained by multiplying the system reference value by, for example, 1.5. In such a manner, the determination of the threshold may be made while changing the power condition for each pulse width.

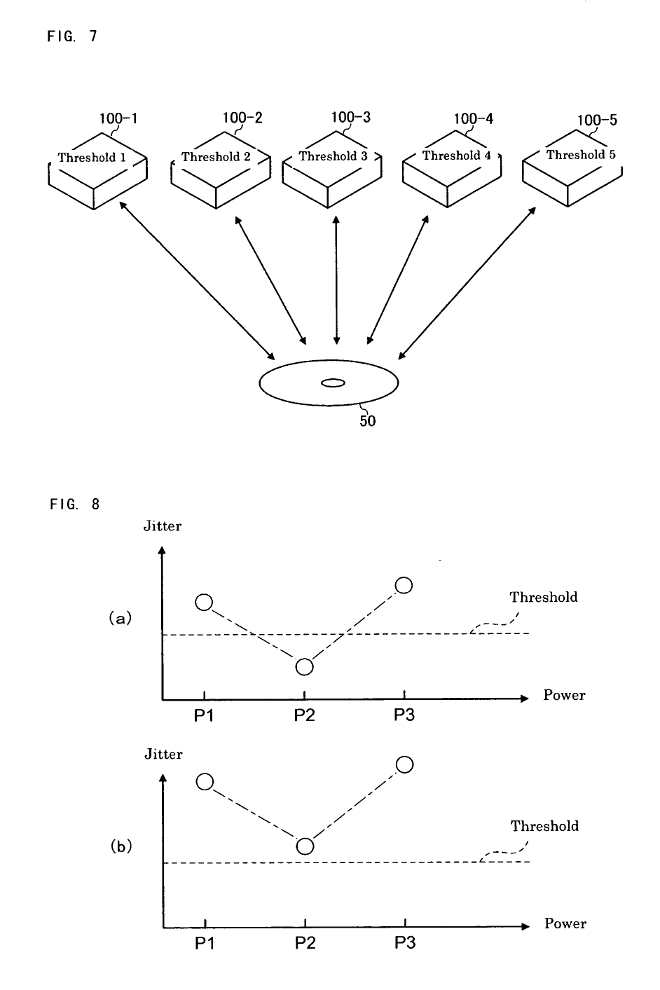

FIG. 7 is a conceptual diagram showing an example when the threshold is calculated for each drive. In the case where the threshold is set preferably depending on the variation in characteristics between the respective drives, the information recorded on the common reference medium 50 is recorded/reproduced by each of drives 100-1 to 100-5, and then the thresholds 1 to 5 specific to the respective drives is stored as shown in FIG. 7.

Moreover, in case of simplifying a setting process for a threshold, a mean value may be calculated from the thresholds 1 to 5 obtained by recording/reproducing the information recorded on the common reference medium by some standard drives, and then the mean threshold may be used as the threshold for other drives.

The standard drives used for calculating the mean threshold may be identically designed ones or similarly designed ones instead of identically designed ones. The mean threshold may also be used as a threshold for the standard drives. Further, the calculated mean threshold may generally be used as a threshold for identically designed or similarly designed drives to be manufactured afterward. In addition, the mean threshold may be determined by calculating a mean value for a plurality of drives that have the variation in characteristics and are intentionally prepared.

Initialization of Recording Apparatus

The step S114 is executed for storing the reference condition and the reference threshold, which are described above and determined at the steps S110 and S112 in FIG. 3 respectively, into the storage region 115 of the drive 100. The step S114 is preferably executed during manufacturing of the drive 100.

Loading Medium to be Recorded

Subsequently, the step S116 is executed for loading the medium 50 onto which the information is to be recorded into the drive 100 already initialized at the step S114.

Recording/Reproducing Under Reference Condition

Under the condition set at the step S114, the step S118 is executed for recording onto the medium 50 loaded at the step S116. Specifically, three jitter values are obtained by recording/reproducing three times using one pulse width and three power values defined as the reference condition. Plotting the three jitter values against the power yields a clear tendency of recording characteristics depending on the combination of the drive 100 and the medium 50.

Inspection of Recording Quality

FIGS. 8A and 8B are conceptual diagrams showing an example of downwardly convex patterns obtained as a result of the inspection of recording quality executed at the step S120 in FIG. 3. As shown in FIGS. 8A and 8B, the recording quality is inspected using a threshold and a jitter value obtained at the preceding steps for each reference condition. The example shown in FIGS. 8A and 8B corresponds to a case where three power values P1, P2, and P3 are used as the reference condition and shows that a virtual line connecting the three jitter values at P1 to P3 exhibits downwardly convex patterns. Such downwardly convex patterns mean that the reference medium used at the step S110 has the same sensitivity as the medium to be recorded loaded at the step S116 and recording characteristics are similar to each other.

FIG. 8A shows a case where the minimum value of the downwardly convex patterns is below the threshold, and FIG. 8B shows a case where the minimum value of the downwardly convex patterns is above the threshold. In either case, the reference medium and the medium to be recorded are considered to have the same sensitivity. When the reference medium and the medium to be recorded have the same sensitivity, as will be described below, a condition to be used for test recording is set as a plane region that is defined by (power)×(pulse width) on the reference condition.

Referring to FIGS. 8A and 8B, a difference between a reproduced value obtained at each of recording points P1, P2, and P3 and a reference reproduced value in FIG. 8A is different from that in FIG. 8B. That is, in the example of FIGS. 8A and 8B, a difference between each of the jitter values and the jitter threshold shown in FIG. 8A is different from that shown in FIG. 8B. The reproduced value in FIG. 8A is closer to the reference reproduced value than that in FIG. 8B.

This means that an optimum condition is easily detected in case of FIG. 8A, as compared with the case of FIG. 8B. Accordingly, when recording characteristics as shown in FIG. 8A are obtained, the number of test runs may be set smaller and more appropriate solution may be found with a smaller number of test runs, as compared with the case of FIG. 8B.

That is, in case that the difference between the reproduced value and the reference reproduced value is small, the optimum condition is close to the above-described reference condition, while the optimum condition is distant from the reference condition in case that the difference is large. Consequently, when the reduction of the number of test recording is desired, it is preferable to vary the number of test runs depending on the difference between the reproduced value and the reference reproduced value.

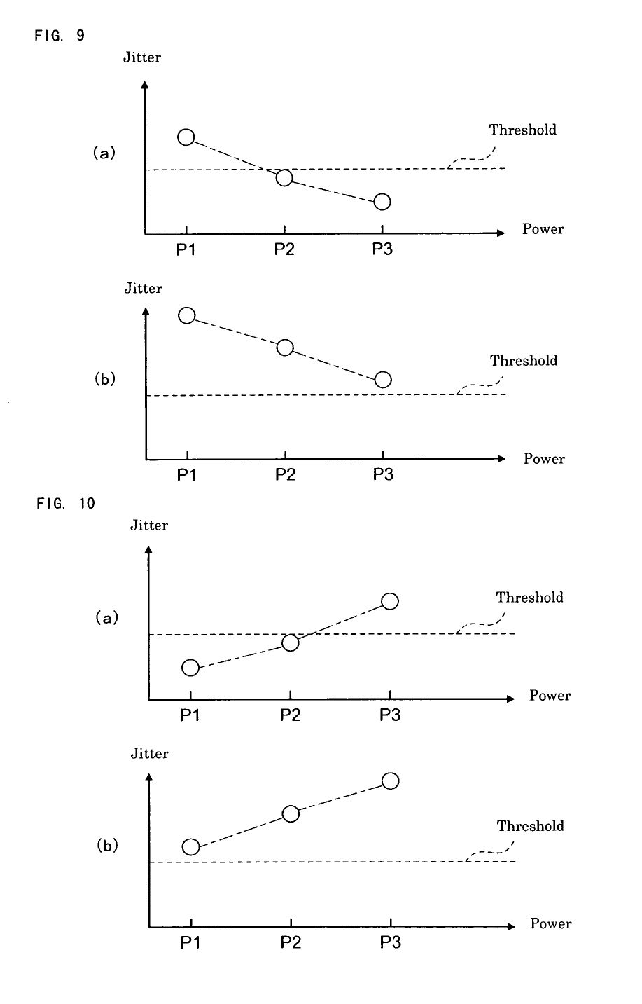

FIGS. 9A and 9B are conceptual diagrams showing an example of downward-sloping patterns obtained as a result of the inspection of recording quality executed at the step S120 in FIG. 3. In the example shown in FIGS. 9A and 9B, the jitter value decreases with increasing the power from P1 to P3, that is, the example shows the downward-sloping patterns. Such downward-sloping patterns mean that the medium to be recorded has lower sensitivity than the reference medium.

FIG. 9A shows a case where the minimum value of the downward-sloping patterns is below the threshold and FIG. 9B shows a case where the minimum value of the downward-sloping patterns is above the threshold. In either case, the medium to be recorded is considered to have lower sensitivity than the reference medium. When the medium to be recorded has the lower sensitivity than the reference medium, as will be described below, test recording is performed by shifting the test region, which is originally defined by (power)×(pulse width) centering on the reference condition, to higher power and wider pulse width sides.

Further, because the minimum jitter value is considered to exist on the higher power side in case of the downward-sloping patterns as shown in FIGS. 9A and 9B, recording characteristics may be checked again by additional recording at a higher power than P3. In this case, the number of recording increases by one, but inspection accuracy can be improved. Moreover, even in case of the downward-sloping patterns, the number of test recording may be varied depending on the difference between the reproduced value and the reference reproduced value, just like the case of the above-described downwardly convex patterns.

Further, in case of the downward-sloping patterns, the optimum solution is considered to be further from the reference condition compared with the case of the downwardly convex patterns described above with reference to FIGS. 8A and 8B. Accordingly, it is preferable to increase the number of test runs, as compared with the case of the downwardly convex patterns.

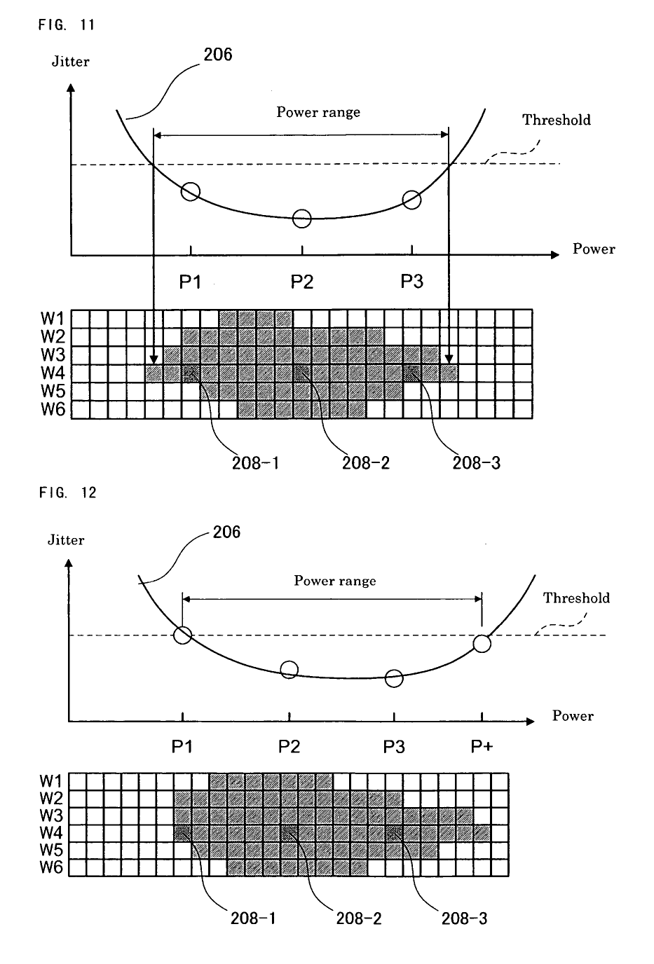

FIGS. 10A and 10B are conceptual diagrams showing an example of upward-sloping patterns obtained as a result of the inspection of recording quality executed at the step S120 in FIG. 3. In the example shown in FIGS. 10A and 10B, the jitter value increases with increasing the power from P1 to P3, that is, the example shows the upward-sloping patterns. Such upward-sloping patterns mean that the medium to be recorded has higher sensitivity than the reference medium.

FIG. 10A shows a case where the minimum value of the upward-sloping patterns is below the threshold and FIG. 10B shows a case where the minimum value of the upward-sloping patterns is above the threshold. In either case, the medium to be recorded is considered to have higher sensitivity than the reference medium. When the medium to be recorded has higher sensitivity than the reference medium, as will be described below, test recording is performed by shifting the test region, which is the plane region defined by (power)×(pulse width) centering on the reference condition, to lower power and narrower pulse width sides.

Further, because the minimum jitter value is considered to exist on the lower power side in case of the upward-sloping patterns as shown in FIGS. 10A ad 10B, recording characteristics may be checked again by additional recording at a lower power than P1. In this case, the number of recording increases by one, but inspection accuracy can be improved. In addition, even in case of the upward-sloping patterns, the number of test runs may be varied depending on the difference between the reproduced value and the reference reproduced value, just like the case of the above-described downwardly convex patterns.

Further, in case of the upward-sloping patterns, the optimum solution is considered to be further from the reference condition compared with the case of the downwardly convex patterns described above with reference to FIGS. 8A and 8B. Accordingly, it is preferable to increase the number of test runs, as compared with the case of the downwardly convex patterns.

Determination of Test Region

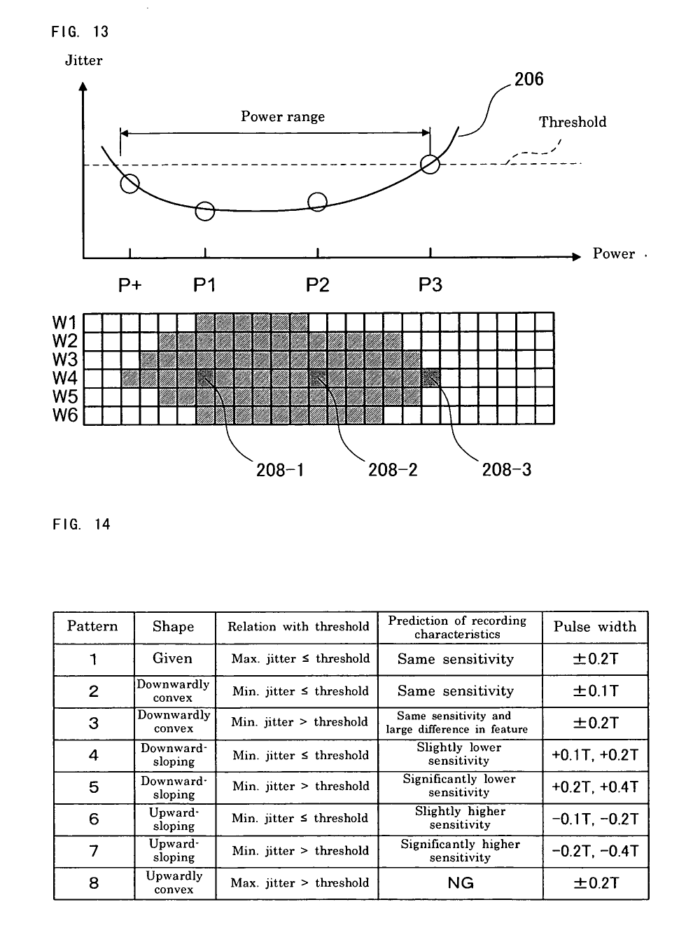

FIG. 11 is a conceptual diagram showing an example of the determination of a test region to be executed at the step S122 in case of the downwardly convex patterns obtained at the step S120 in FIG. 3. As shown in FIG. 11, in case of the downwardly convex patterns, a region between cross points of an approximated curve 206 for the jitter values at P1, P2, and P3 with the threshold is set to a power change region to be used for test recording. In one embodiment, the power change region to be actually used for test recording is defined as ‘power range’, and a power region having a jitter equal to or less than the threshold is defined as a ‘power margin’.

The approximated curve 206 varies depending on the pulse width. Accordingly, in case that the pulse width used as the reference condition is W4, recording is performed at the power values of P1, P2, and P3 for each of the pulse widths W1 to W6 centering on W4. Consequently, the approximated curve 206 can be obtained for each of the pulse widths W1 to W6, and the cross points of the approximated curve 206 with the threshold can be checked for each pulse width. Accordingly, a power range having a jitter equal to or less than the threshold is obtained for each pulse width and a hatched region in a matrix shown in FIG. 11 is applied to a test region. Here, in the matrix, the three power values P1, P2 and P3 in association with the pulse width W4 used as the reference condition are indicated as 208-1, 208-2, and 208-3 in FIG. 11, respectively. Accordingly, it can be considered that the determined test region is set as a plane region that is defined by (power)×(pulse width) centering on the reference condition.

As such, because obtaining the power range for each pulse width can lead to intensive test runs in the region having a jitter equal to or less than the threshold, more appropriate condition may be found with a smaller number of test runs.

Moreover, the number of test runs can be reduced by setting a larger step amount for a power change in case of a large power margin or by setting a smaller step amount for a power change in case of a small power margin. For example, in case of a 10 mW margin, test recording may be performed five times with a step amount of 2 mW, assuming that an optimum value can be obtained even with rough tests. On the other hand, in case of a 1 mW margin, test recording may be performed ten times with a step amount of 0.1 mW due to the necessity of precise tests.

FIG. 12 is a conceptual diagram showing an example of the determination of a test region to be executed at the step S122 in case of the downward-sloping patterns obtained at the step S120 in FIG. 3. As shown in FIG. 12, because the optimum condition is considered to exist on a higher power side in case of the downward-sloping patterns, additional recording is performed at the power value of P+ higher than P3, and the region between cross points of an approximated curve 206 for the jitter values at P1, P2, P3, and P+ with the threshold is applied to a power range as shown in FIG. 12. This process is performed for each of the pulse widths W1 to W6, whereby the test region can be obtained, as shown in a matrix in FIG. 12.

The test region determined in such a procedure has a shape in which a plane region defined by (power)×(pulse width) centering on the reference condition 208-1, 208-2, and 208-3 is shifted to a higher power side. In case of the downward-sloping patterns, a power range may be determined by shifting the test region to a wider pulse width region from the pulse widths W1 to W6 due to low sensitivity of the medium to be recorded, although the example uses the pulse widths W1 to W6, which are used for the case of the downwardly convex patterns.

FIG. 13 is a conceptual diagram showing an example of the determination of a test region to be executed at the step S122 in case of the upward-sloping patterns obtained at the step S120 in FIG. 3. As shown in FIG. 13, because the optimum condition is considered to exist on a lower power side in case of the upward-sloping patterns, additional recording is performed at the power value P+ lower than P1 and the region between cross points of an approximated curve 206 for the jitter values at P+, P1, P2 and P3 with the threshold is applied to a power range as shown in FIG. 13. This process is performed for each of the pulse widths W1 to W6, whereby the test region can be obtained, as shown in a matrix in FIG. 13.

The test region determined in such a procedure has a shape in which a plane region defined by (power)×(pulse width) centering on the reference condition 208-1, 208-2, and 208-3 is shifted to a lower power side. In case of the upward-sloping patterns, a power range may be determined by shifting the test region to a narrower pulse width region from the pulse widths W1 to W6 due to high sensitivity of the medium to be recorded, although the example uses the pulse widths W1 to W6, which are used for the case of the downwardly convex patterns.

That is, in the above-described method, because recording quality is inspected for each pulse width and the number of test runs is determined for the each pulse width based on the inspection result, the reduction in the number of test runs can be expected. The inspection of recording quality described above is an example of a case where the inspection is performed by patterning a jitter change depending on recording under the reference conditions. More preferably, it is recommended to perform the inspection by using eight patterns described below.

FIG. 14 is a diagram showing an example of a case where the step 120 in FIG. 3 is executed by using eight patterns. As shown in FIG. 14, the pattern 1 is a pattern to be applied in case that the maximum jitter value is equal to or less than the threshold, regardless of the downwardly convex, upward-sloping, and downward-sloping patterns. In case of the pattern 1, a power condition is expanded to lower and higher power sides based on an idea that a larger margin having a jitter equal to or less than the threshold can be ensured, in addition to an idea that the medium to be recorded has comparable sensitivity with the reference medium. That is, in case of the pattern 1, because a value in the vicinity of the threshold is not obtained, additional recording is performed on lower and higher power sides.

Subsequently, a curve approximation is performed for jitter characteristics obtained from additional recording and the region between two cross points of the approximated curve with the jitter threshold is applied to a reference power range.

Further, in case of the pattern 1, the pulse width region of the reference value ±0.2 T is determined as the test region and the optimum recording condition is detected while changing the pulse width by 0.2 T at a time in the test region during test recording, where T represents a unit time length of a recording pit.

If the pulse width serving as the reference value is denoted by a pulse condition 1 and the two expanded points are denoted by pulse conditions 2 and 3, the pulse conditions 2 and 3 of the pattern 1 correspond to the pulse widths after the ±0.2 T expansion respectively. With the change of the pulse width condition, a power range to be used as a test condition is also slightly changed.

For example, when a pulse width is varied by 0.1 T, (reference power range)×(1−0.05×1) mW is applied to a power range for the changed pulse width. Further, when a pulse width is changed by 0.2 T, (reference power range)×(1−0.05×2) mW is applied to a power range for the changed pulse width, and when a pulse width is changed by −0.1 T, (reference power range)×(1−0.05×(−1)) mW is applied to a power range for the changed pulse width.

Accordingly, in case of the pattern 1, the test condition involves the following three sets:

(1) Reference pulse width and Reference power range

(2) (Reference pulse width)−0.2 T, and (Reference power range)×(1−0.05×(−2)) mW

(3) (Reference pulse width)+0.2 T, and (Reference power range)×(1−0.05×(+2)) mW

Moreover, in one embodiment, the reference condition shown in the above-described (1) is not necessarily used for actual test recording.

The pattern 2 corresponds to the case of downwardly convex patterns and can be applied when the minimum jitter value is equal to or less than the threshold. In case of the pattern 2, ((reference pulse width) ±0.1 T) is selected as the pulse width condition based on an idea that the medium to be recorded has the same sensitivity as the reference medium. Subsequently, by the same procedure as that of the pattern 1, the power range is set for each of the pulse widths. Consequently, the test condition in case of the pattern 2 involves the following three sets:

(1) Reference pulse width and Reference power range

(2) (Reference pulse width)−0.1 T, and (Reference power range)×(1−0.05×(−1)) mW

(3) (Reference pulse width)+0.1 T, and (Reference power range)×(1−0.05×(+1)) mW

The pattern 3 corresponds to the case of downwardly convex patterns and can be applied when the minimum jitter value is more than the threshold. In case of the pattern 3, ((reference pulse width) ±0.2 T) is selected as the pulse width condition, based on an idea that the medium to be recorded has the same sensitivity as the reference medium and the difference in feature between them is large. Subsequently, by the same procedure as that of the pattern 1, the power range is set for each of the pulse widths. Consequently, the test condition in case of the pattern 3 involves the following three sets:

(1) Reference pulse width and Reference power range

(2) (Reference pulse width)−0.2 T, and (Reference power range)×(1−0.05×(−2)) mW

(3) (Reference pulse width)+0.2 T, and (Reference power range)×(1−0.05×(+2)) mW

The pattern 4 corresponds to the case of downward-sloping patterns and can be applied when the minimum jitter value is equal to or less than the threshold. In case of the pattern 4, three points including the reference pulse width, ((reference pulse width)+0.1 T), and ((reference pulse width)+0.2 T) are selected as the pulse width condition based on an idea that the medium to be recorded has slightly lower sensitivity than the reference medium. Subsequently, by the same procedure as that of the pattern 1, the power range is set for each of the pulse widths. Consequently, the test condition in case of the pattern 4 involves the following three sets:

(1) Reference pulse width and Reference power range

(2) (Reference pulse width)+0.1 T, and (Reference power range)×(1−0.05×(+1)) mW

(3) (Reference pulse width)+0.2 T, and (Reference power range)×(1−0.05×(+2)) mW

The pattern 5 corresponds to the case of downward-sloping patterns and can be applied when the minimum jitter value is more than the threshold. In case of the pattern 5, three points including the reference pulse width, ((reference pulse width)+0.2 T), and ((reference pulse width)+0.4 T) are selected as the pulse width condition, based on an idea that the medium to be recorded has significantly lower sensitivity than the reference medium. Subsequently, by the same procedure as that of the pattern 1, the power range is set for each of the pulse widths. Consequently, the test condition in case of the pattern 5 involves the following three sets:

(1) Reference pulse width and Reference power range

(2) (Reference pulse width)+0.2 T, and (Reference power range)×(1−0.05×(+2)) mW

(3) (Reference pulse width)+0.4 T, and (Reference power range)×(1−0.05×(+4)) mW

The pattern 6 corresponds to the case of upward-sloping patterns and can be applied when the minimum jitter value is equal to or less than the threshold. In case of the pattern 6, three points including the reference pulse width, ((reference pulse width)−0.1 T), and ((reference pulse width)−0.2 T) are selected as the pulse width condition, based on an idea that the medium to be recorded has slightly higher sensitivity than the reference medium. Subsequently, by the same procedure as that of the pattern 1, the power range is set for each of the pulse widths. Consequently, the test condition in case of the pattern 6 involves the following three sets:

(1) Reference pulse width and Reference power range

(2) (Reference pulse width)−0.1 T, and (Reference power range)×(1−0.05×(−1)) mW

(3) (Reference pulse width)−0.2 T, and (Reference power range)×(1−0.05×(−2)) mW

The pattern 7 corresponds to the case of upward-sloping patterns and can be applied when the minimum jitter value is more than the threshold. In case of the pattern 7, three points including the reference pulse width, ((reference pulse width)−0.2 T), and ((reference pulse width)−0.4 T) are selected as the pulse width condition, based on an idea that the medium to be recorded has significantly higher sensitivity than the reference medium. Subsequently, by the same procedure as that of the pattern 1, the power range is set for each of the pulse widths. Consequently, the test condition in case of the pattern 7 involves the following three sets:

(1) Reference pulse width and Reference power range

(2) (Reference pulse width)−0.2 T, and (Reference power range)×(1−0.05×(−2)) mW

(3) (Reference pulse width)−0.4 T, and (Reference power range)×(1−0.05×(−4)) mW

The pattern 8 corresponds to the case of upwardly convex patterns and can be applied when the maximum jitter value is more than the threshold. In case of the pattern 8, ((reference pulse width)±0.2 T) is selected as the pulse width condition, based on an idea that the patterns are abnormal. Subsequently, by the same procedure as that of the pattern 1, the power range is set for each of the pulse widths. Consequently, the test condition in case of the pattern 8 involves the following three sets:

(1) Reference pulse width and Reference power range

(2) (Reference pulse width)−0.2 T, and (Reference power range)×(1−0.05×(−2)) mW

(3) (Reference pulse width)+0.2 T, and (Reference power range)×(1−0.05×(+2)) mW

Moreover, in case of the detection of a pattern other than the pattern 2 that is closest to the reference medium among the eight patterns, a jitter may be detected again by further reproducing the recording result from which the pattern is obtained in order to confirm that the pattern is not due to a reproducing error. In this case, if a pattern other than the pattern 2 is again detected by the further reproduction, the recording condition may be added and expanded according to the condition shown in FIG. 14.

Here, in case of the detection of the pattern 8 as a result of the above-described confirmation of the reproducing error, because the recording error can be considered, recording is again performed with the reference pulse width before additional recording or pulse width expansion. If the pattern 8 is once again detected by reproducing recording, additional recording is performed with the pulse width expansion, that is, the expansion of the pulse conditions 2 and 3, instead of the power extension to measure the margin for the pulse condition 1. The power expansion according to the expansion of the pulse conditions 2 and 3 may be performed by the above-described method.

That is, in case of the pattern 8, the margin cannot be ensured under the pulse condition 1, and therefore the power range that is a basis for the power extension cannot be obtained. Accordingly, an initial power condition is set as the reference power range.

Determination of Test Region: Determination of Power Range by Approximation Method

The test region effective for obtaining the optimum solution with a smaller number of test runs is determined by performing the above-described method. In addition, a method for the determination of the power range important to the determination of the test region will hereinafter be described.

In one embodiment, in order to improve the accuracy of finding the optimum solution with the smallest possible number of test runs, the test condition is focused on the region in which a jitter is equal to or less than the threshold or less, as described above. According to this concept, the power range to be used for test recording may be obtained from two power values that indicate the margin for the threshold. The margin for the threshold means a range in which a characteristic value equal to or less than the threshold can be obtained, and the two power values mean values on the lower and higher power sides that define the margin range.

Considering the reduction in test recording time and the efficient use of a test recording region of a medium, such as a write-once medium, in which the test recording region is limited, the number of recording points for test recording is preferably smaller. However, higher accuracy is much more needed for the power range because the power range is an important parameter as a judgment reference of the optimum recording condition.

Because obtaining the accurate power range leads to the test runs that are to be performed intensively in a more accurately selected region, it contributes to the reduction in the number of test runs. For example, when test recording is performed at a frequency of once per 0.1 mW, test recording is performed ten times for the power range of 1 mW. Further, in case of 2 mW, test recording is performed twenty times. Accordingly, narrowing a power range contributes to the reduction in the number of test runs.

Therefore, one embodiment propounds a method for obtaining a desired margin amount by approximating a characteristic curve using some recorded points, paying attention to recording quality of recording/reproducing signals that shows a change like a quadratic curve having an extreme value as an optimum point against recording power. Application of such an approximation method allows the power range with high accuracy to be easily obtained with some recording points and can reduce the number of test runs.

FIG. 15 is a conceptual diagram illustrating the method for obtaining a power range, which is used at the step S122 in FIG. 3, by the curve approximation. As shown in FIG. 15, two points a and c and a point b are first selected for the approximation. The two points a and c are located on lower and higher power sides respectively and of which jitter values are in the vicinity of the threshold which serves as the reference for recording characteristics. And then, a point b which is located between the two points a and c and of which a jitter value is below the jitter values of the points a and c and the threshold is selected. That is, the points a, b and c to be selected have the following relationships:
a>b, c>b, and threshold>b

The term ‘vicinity’ of the threshold is defined as a range between the upper and lower limits that are higher and lower than the threshold by certain amounts respectively. Preferably, the upper and lower limits are set to be higher and lower than the threshold by 40% and 5% thereof respectively. The a, b and c values are then approximated with a quadratic function and the region between the two cross points of the quadratic function with the threshold is applied to the power range. Moreover, the range to be defined as the vicinity of a threshold may be changed, such as −5% to +40%, −10% to +30%, or the like, in consideration of the interval between the recording points.

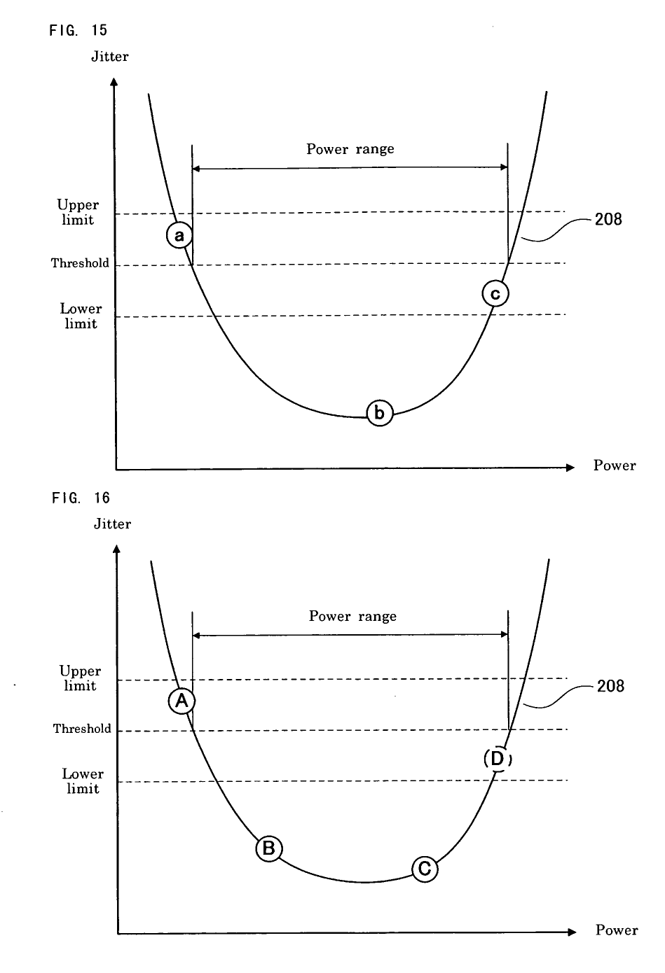

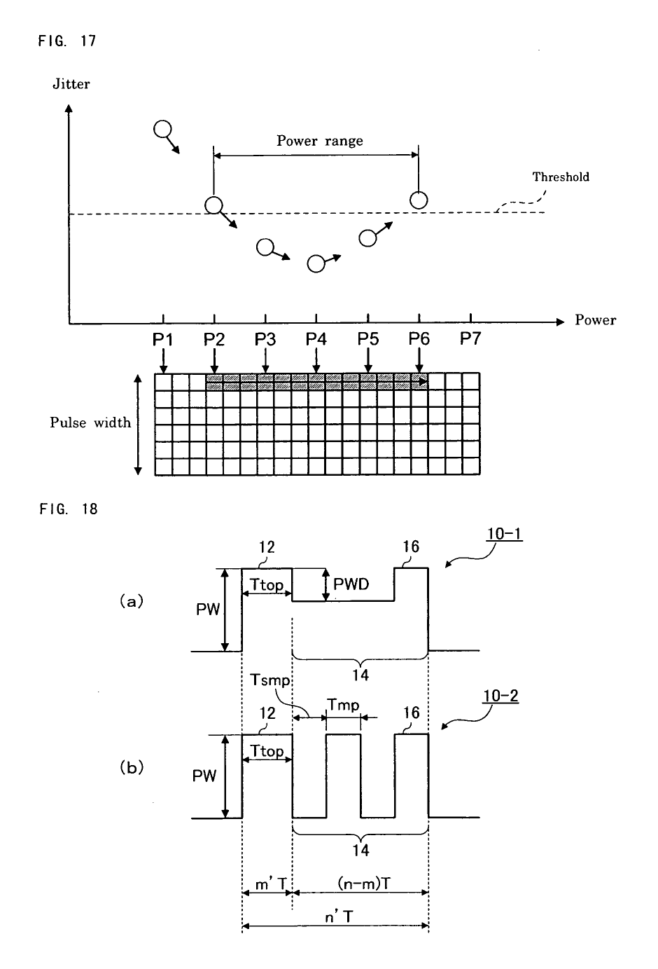

FIG. 16 is a conceptual diagram illustrating another example of obtaining a power range, which is used at the step S122 in FIG. 3, by the curve approximation. In case that a set of three points A, B, and C shown in FIG. 16 do not meet the above described conditions ‘a>b, c>b, and threshold>b’, it is preferable to obtain a value in the vicinity of the threshold by additional recording of the point D on a higher power side.

In addition, in the case of B>C, as shown in FIG. 12, it is preferable to obtain an approximate expression with the three points A, C, and D without using the point B.

At this time, because the relationship between the three recording points and the threshold are ‘A>C, D>C, and threshold>C’, which are appropriate for drawing an approximated curve, the approximated curve with high accuracy can be obtained with a three-point approximation. Moreover, an additional recording condition for the point D may be determined depending on the relationship among the recording points A, B, and C before additional recording, that is, ‘A>B and B>C’, and on the threshold.

Further, in case that a jitter value does not exist in the vicinity of the threshold on a lower power side, contrary to the case of FIG. 15, additional recording may be performed under a lower power condition than the case of A. Additional recording may be performed under one or more recording conditions depending on the relationship of the recording points and the threshold.

A power to be used for additional recording reference may be changed with a power step different from a predetermined power step and a power condition included in the additional recording condition may be set based on the previously obtained relationship of the change in jitter to the change in power.

In addition, in case that recording points enough to determine the power range are not obtained even with the additional recording condition described above, another recording point should be obtained again by adding a further recording condition by the same procedure as described above.

In case of a write-once medium, the test recording region of which is limited, in order to avoid the use of a large amount of test time, the number of the above-described additional recording conditions may have an upper limit, and an additional recording power may have an upper limit so as not to exceed a laser power due to the addition of the recording condition.

Further, in the above-described example, the power range is determined by the three-point approximation, but a power range may be determined in such a manner that two closest points to the threshold are first selected and then a different between two power values corresponding to the two closest points is applied to the power range.

An alternative method for selecting two points in the vicinity of the threshold may include, after recording is performed while changing a power until two points located on either side of the threshold is found, selecting two closest points to the threshold among the recording points or selecting the two points located on either side of the threshold. The method will hereinafter be described in detail.

Determination of Test Region: Determination of Power Range by Sampling

FIG. 17 is a conceptual diagram illustrating an example of the determination of a power range, which is used at the step S122 in FIG. 3, by sampling. The example shows that a power range is determined based on two power values corresponding to the two closest points to the threshold, which are obtained after test recording by gradually changing a power until two values close to the threshold are obtained, instead of using the above-described three-point approximation.

That is, as shown in FIG. 17, recording/reproducing is repeatedly performed by increasing a recording power in order of P1, P2, P3, . . . , and P6 at which a value equal to or more than the threshold is obtained. As shown in a matrix in FIG. 17, a power range is determined as a range between P2 and P6 which are the two closest points to the threshold and are located on lower and higher power sides respectively, while the power changes from P1 to P6. As such, the power range can be determined by selecting two points located on either side of the threshold.

A method for selecting two points which are close to the threshold involves the following methods, one of which may be selected and used from time to time:

(1) A method for selecting two points which define the power margin, that is, selecting two points which are located in a power region meeting the reference reproduced value and are both the two closest points to the reference reproduced value

(2) A method for selecting two points which are located slightly outside the power margin and are both the two closest points to the reference reproduced value

(3) A method for selecting two points which are located on the lower power side and on either side of the reference reproduced value

(4) A method for selecting two points which are located on the higher power side and on either side of the reference reproduced value

(5) A method for selecting two points which are located on the lower and higher power sides respectively and on either side of the reference reproduced value and which are both the two closest points to the reference reproduced value

Further, an alternative method may further include selecting two cross points of an approximated curve, which is obtained using the two points selected by any one of the above-described methods, with the reference reproduced value.

Determination of m′T/(n−m)T Ratio

FIGS. 18A and 18B are conceptual diagrams showing an example of a recording pulse for test recording to be used for the determination of the ratio at the step 200 shown in FIG. 1B. FIG. 18A shows an example of a case where a single pulse having a single pulse pattern is used and FIG. 18b shows an example of a case where a multi-pulse having multiple pulses is used. As shown in FIGS. 18A and 18B, each of the single pulse 10-1 and the multi-pulse 10-2 has a top pulse 12 located at the forefront of the recording pulse and a following pulse 14 following the top pulse 12. The following pulse 14 has a back-end pulse 16 located at the end of the recording pulse.

Here, an energy amount of the entire recording pulse is defined by the height of a main power PW and the length of a top pulse width Ttop defines an energy amount of the initial stage of the recording pulse that is provided to the front edge of a recording pit. The main power PW preferably corresponds to the highest value in each of the recording pulses 10-1 and 10-2, and the top pulse width Ttop has a width corresponding to the shortest recording pit having a length of 3T. Because the recording pulse having the shortest pulse width has the highest appearance probability and significantly influences recording quality, optimum conditions of the power PW and the width Ttop of the top pulse 12 are first determined by the m′T condition determination flow described above.

Subsequently, a condition of the following pulse 14 is determined by the m′T/(n−m)T ratio determination flow. In case of the single pulse 10-1, as shown in FIG. 18A, by a power region lower than the main power PW by an amount of PWD and by defining the PWD amount, the recording pit is prevented from being formed in the shape of a tear drop. Similarly, in case of the multi-pulse 10-2, as shown in FIG. 18B, defining either the width Tmp of an intermediate pulse located between the top pulse 12 and the back-end pulse 16 or defining a duty ratio of Tmp to Tsm prevents the recording pit from being formed in the shape of a tear drop. The determination of a condition for each of the following pulses is performed with the condition of the top pulse as a reference.

FIG. 19 is a flow chart showing an execution procedure of the ratio determination flow at the step S200 shown in FIG. 1B. As shown in FIG. 19, the drive shown in FIG. 2 first performs test recording onto the medium 50 with a plurality of recording patterns having various (n−m)T conditions, in order to set various parameters of a recording strategy which is to be performed by the strategy circuit 102 (Step S210). At the step 210, an mT pulse condition is fixed to a value obtained by the above-described m′T condition determination flow.

Next, after the recorded patterns formed by test recording are reproduced (Step S212), reproduced binarized signals output from the binarization circuit 110 as a result of the reproduction are counted by a counter, which is synchronized with a predetermined clock, in a recording shift detection part 112 (Step S214). Then, the lengths of pits and lands included in the reproduced binarized signals are stored in the storage region 115 as count data (Step S216).

Next, the recording shift detection part 112 prepares a histogram representing an appearance frequency for every count by using count data stored in the storage region 115 (Step S218). Then, the thresholds for count results that are to be reference for the lengths of pits and lands are determined from the histogram (Step S220).

Subsequently, the recording shift detection part 112 searches various types of specific patterns including a specific pit/land pattern from count data stored in the storage region 115 with the thresholds as references (Step S222). Next, average lengths of respective pits and respective lands constituting the specific patterns are calculated by averaging the count results for the pits considered to have the same pit length included in the specific patterns and by averaging the count results for the lands considered to have the same land length (Step S224).

Subsequently, the recording shift detection part 112 sets one of various types of specific patterns extracted as an extracted pattern, and compares the length of a recording pit included in the extracted pattern with a reference length (Step S226). Next, the recording shift detection part 112 detects a shift length of the pit with respect to the recording pulse (Step S228).

Subsequently, an equation derivation part 113 derives an equation for determining an optimum strategy based on the shift length detected by the recording shift detection part 112. A strategy determination part 14 predicts a control result by various parameters by using the equation derived by the equation derivation part 113 (Step S230). Further, the strategy determination part 14 determines PWD or Tmp shown in FIGS. 18A and 18B based on the prediction and then sets the determined PWD or Tmp to the strategy circuit 102 (Step S232).

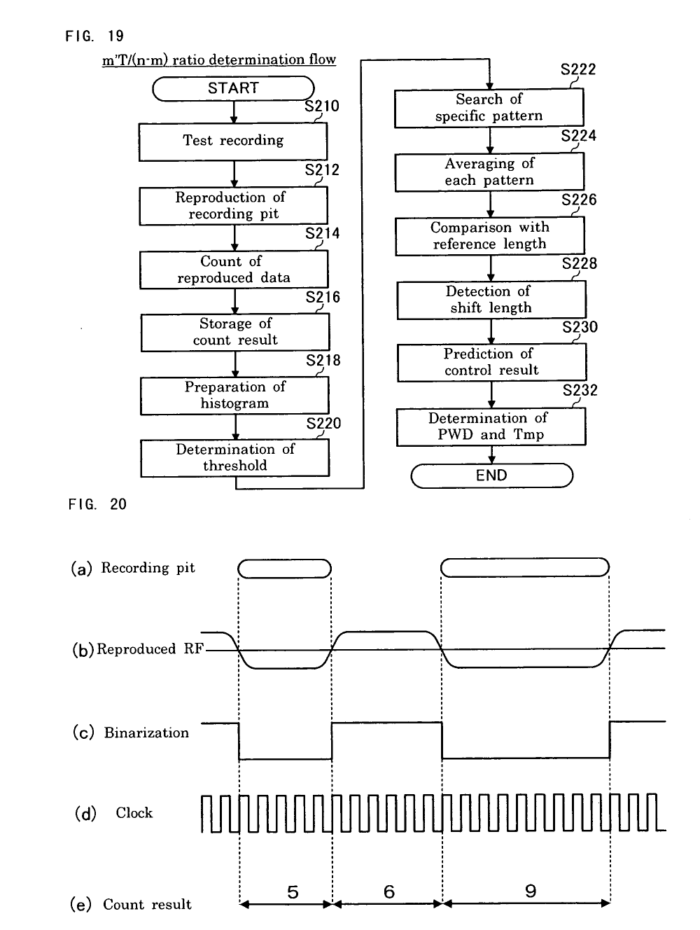

FIG. 20 is a conceptual diagram showing an operation concept from test recording to the count of reproduced data shown in FIG. 19. As shown in FIG. 20, recording pits as shown in (a) are first formed on an optical disc when test recording is performed. By reproducing the recording pits, a reproduced RF signal corresponding to the recording pits is obtained, as shown in (b). A reproduced binarized signal as shown in (c) is obtained by binarizing the reproduced RF signal, and by counting pulse lengths between two polarity inversions of the binarized signal with a clock signal as shown in (d), count results are obtained as shown in (e).

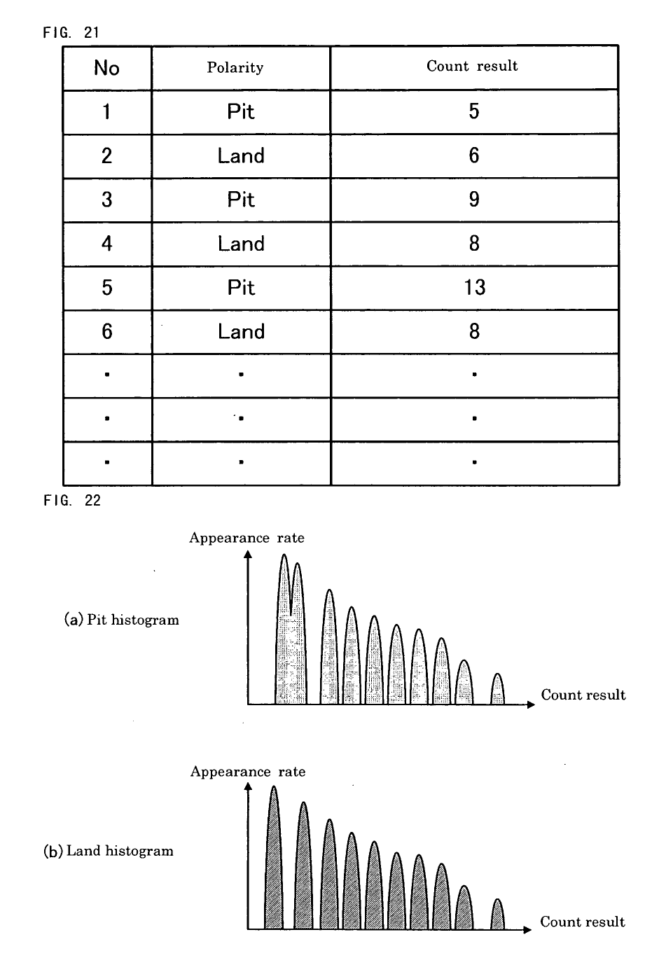

FIG. 21 is a conceptual diagram showing the storage of the count results shown in FIG. 19. As shown in FIG. 21, the count results obtained by counting the binarized signal with the clock signal for respective pits and lands, which can be delimited with polarity inversions, are stored in a table provided in the storage region 115 along with distinctive notations between a pit and a land in time-series sequence. The table shown in FIG. 21 is to be stored with a subsequently searchable address.

FIGS. 22A and 22B are conceptual diagrams showing the histogram preparation shown in FIG. 19. As shown in FIGS. 22A and 22B, two different histograms representing count tendencies for pits and lands (FIGS. 22A and 22B) can be obtained by graphing appearance frequencies of counts for the pits and the lands respectively. As such, because each unit length nT (where n=3, 4, 5, . . . , and 14) with respect to a reference clock is inevitably determined in an optical disc, the peak of an appearance frequency distribution is obtained for the each unit length nT.

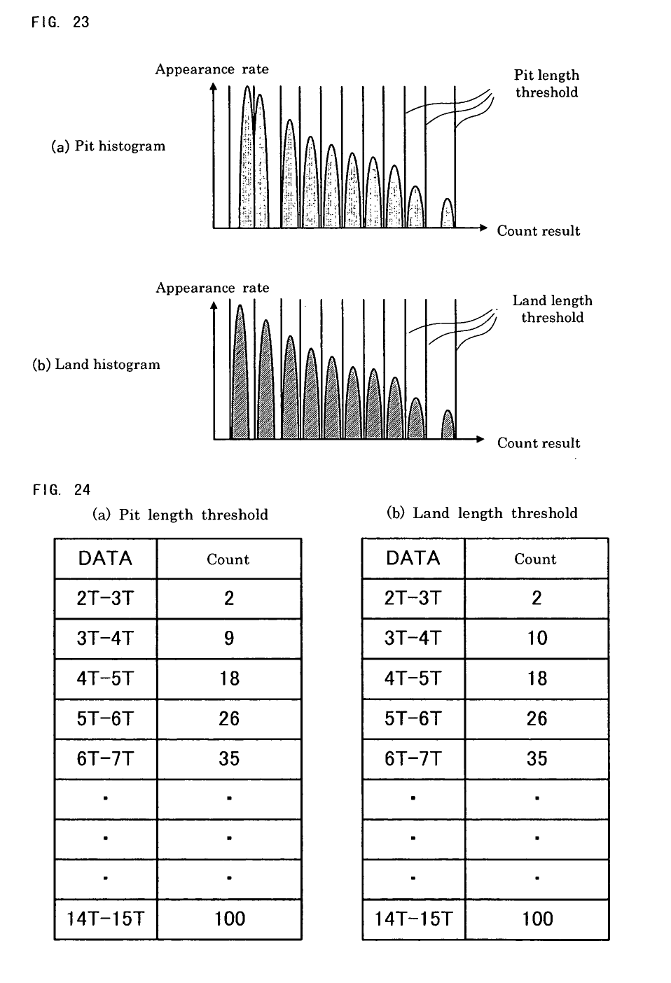

FIGS. 23A and 23B are conceptual diagrams showing the threshold determination shown in FIG. 19. As shown in FIGS. 23A and 23B, because a valley portion between two adjacent peaks in the histograms can be used for the reference threshold for each unit length nT, a pit length threshold to be a reference for a pit length and a land length threshold to be a reference for a land length are set in the pit and land histograms, respectively.

FIGS. 24A and 24B are conceptual diagrams showing an example of thresholds obtained by the method described with reference to FIGS. 23A and 23B. The pit length threshold is defined at a boundary between the pits, and the land length threshold is defined at a boundary between two lands as shown in FIGS. 24A and 24B, respectively. As shown in FIG. 24A, for example, a threshold at the boundary between 2T and 3T is set as ‘count=2’ and a threshold at the boundary between 3T and 4T as ‘count=9’. Similarly, threshold setting is performed up to the boundary between 14T and 15T. Further, in the example shown in FIG. 24B, a threshold at the boundary between 2T and 3T is set as ‘count=2’ and a threshold at the boundary between 3T and 4T as ‘count=10’. Similarly, threshold setting is performed up to the boundary between 14T and 15T.

The details of respective steps from the search of specific patterns (Step S222) to the detection of shift lengths (Step S228) shown in FIG. 19 will hereinafter be described. These steps are performed by the recording shift detection part 112 based on detection principles for various shifts.

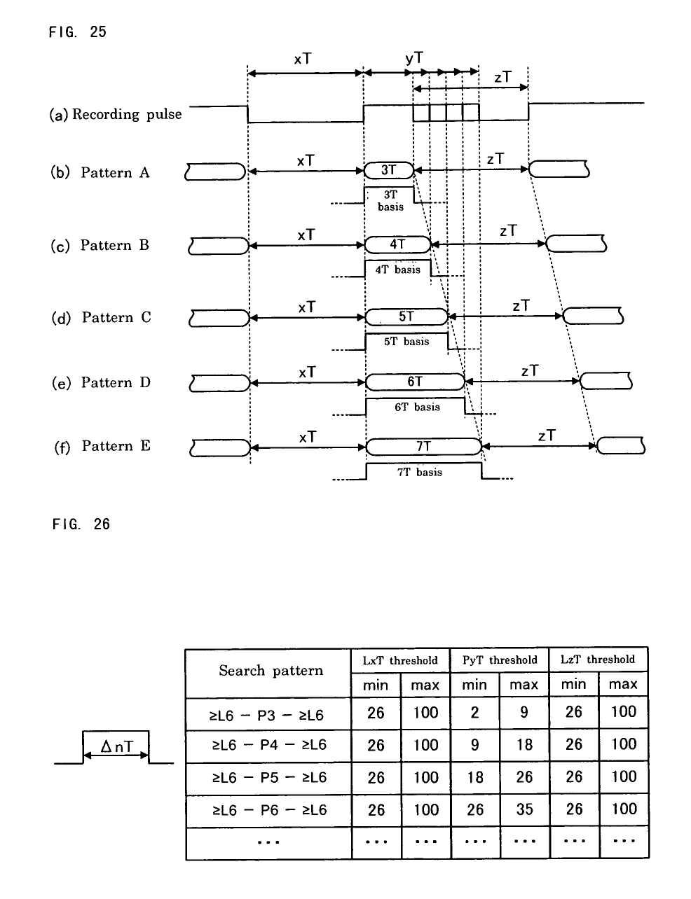

FIG. 25 is a diagram showing an example of a recording pattern to detect a shift amount due to a pit balance. The pit balance is defined as a balance between top and following pulses. As shown in FIG. 25, in case of detecting the shift length due to the pit balance, test recording is performed with a recording pulse shown in (a). The recording pulse includes a pattern successively having a land LxT, a pit PyT, and a land LzT. Here, land lengths of the land LxT and the land LzT are fixed, while a pit length of the variable pit PyT is changed from 3T to 7T as shown in (b) to (f). Moreover, though not shown, the pit length of the variable pit PyT is changed up to 14T.

If the length of the variable pit PyT is measured, the length of the variable pit PyT should correspond to a predetermined pit length in an ideal recording condition.

However, in case that the length of the variable pit PyT is shifted with respect to the predetermined pit length, the shift amount from the defined length of the variable pit PyT corresponds to the shift length of the pit length of each of the pits P3T to P14T, that is, 3T to 14T, relative to the recording pulse generated with a strategy during recording because the land lengths of the lands LxT and LzT are both fixed.

Accordingly, using the reproduced pattern for test recording performed with a certain strategy, as shown in (b) to (f) of FIG. 25, a shift amount from an ideal length of each pit can be detected by comparing the recorded result of each variable pit PyT with the reference length for each pit, thereby detecting the shift length of each pit.

FIG. 26 is a conceptual diagram showing the configuration of a table for searching specific patterns to be used for the detection of the shift due to the pit balance. In case of detecting the shift length due to the pit balance, data stored in the storage region 115 shown in FIG. 2 are searched (Step S222 in FIG. 19) based on a set of threshold ranges for the land LxT, the pit PyT, and the land LzT prepared for each specific pattern and a data row satisfying the threshold ranges is extracted.

Subsequently, count results for each of the land LxT, the pit PyT, and the land LzT are sorted, and the sorted count results are then averaged for each of the land LxT, the pit PyT, and the land LzT (Step S224 in FIG. 19). By comparing a pattern as shown in FIG. 25 using the averaged value of the count results, a phase shift amount on the front side of each pit can be obtained.

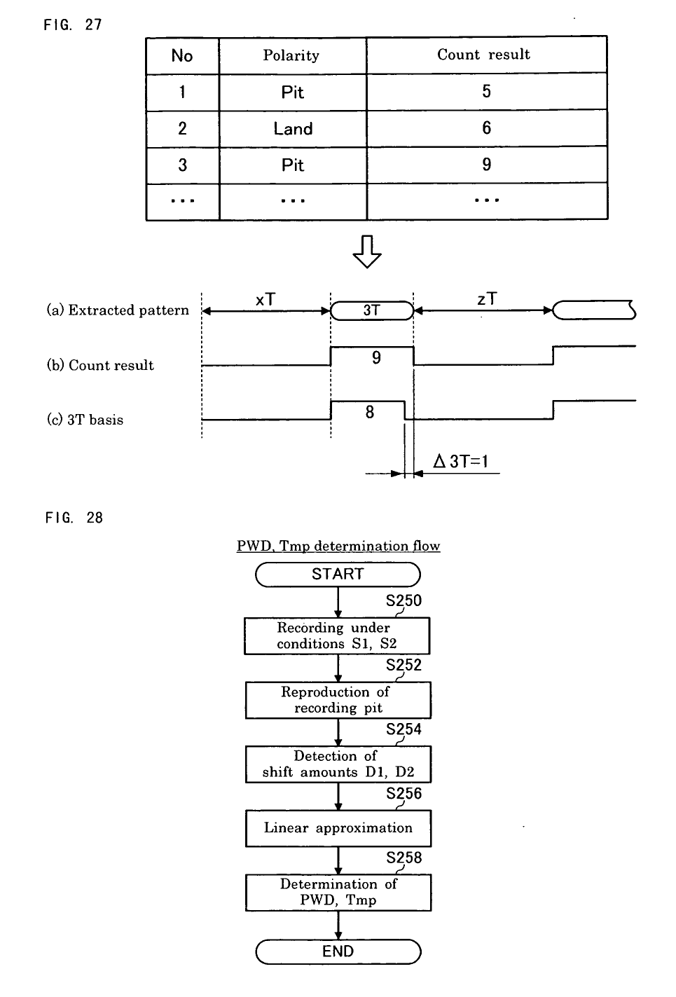

FIG. 27 is a conceptual diagram showing a specific example of a case where a shift length is detected by an absolute comparison of count results. When a shift length is detected through the comparison with an ideal reference length, a specific pattern shown in (a) is first extracted from a group of data stored in the storage region, and then a count in the specific pattern and a count for the reference length are compared with each other with respect to a part to be compared as shown in (b) and (c). In this example, since the part to be compared corresponds to a 3T pit, a difference between the count ‘9’ in the specific pattern as shown in (c) and the count ‘8’ corresponding to the reference length as shown in (d) is calculated. Consequently, the calculated difference ‘1’ is applied to the shift length for the 3T pit.

FIG. 28 is a flow chart showing an execution example of the prediction of a control amount shown in FIG. 19. As shown in FIG. 28, the prediction of a control amount is performed in such a manner that test recording is first performed under at least two different recording conditions S1 and S2 (Step S250), obtained recording pits are reproduced (Step S252), a shift length D1 for the condition S1 and a shift length D2 for the condition S2 are obtained by comparing the reproduced patterns (Step S254), the relationship between (S1, D1) and (S2, D2) is linearly approximated (Step S256), and an optimum correction amount is finally determined by using the approximated line (step S258).

The shift lengths D1 and D2 detected as described above vary depending on various setting parameters of a strategy. And then, it has been found that the shift varying depending on various setting parameters of the strategy changes almost linearly as a result of analysis.

That is, the shift length to be detected for each test recording by the above-described recording shift detection part 112 can be considered as a point on a line approximated by a least-square method.

Therefore, in the drive of one embodiment, an optimum strategy can be determined in consideration of the linear relationship between various setting parameters of the strategy and the detected shift lengths D1 and D2 in case that test recording is performed two times. Besides, in the embodiment, a curve approximation may also be used instead of the linear approximation.

That is, PWD in case of the single pulse or Tmp in case of the multi-pulse is a typical parameter to be changed depending on the recording condition S1 or S2. With changing the parameter from S1 to S2, the effect of the change on the shift length is detected as the change from D1 to D2. Using the four values, the linear approximation is performed and the use of the approximated line results in obtaining the correction amount that can cancel the shift length.

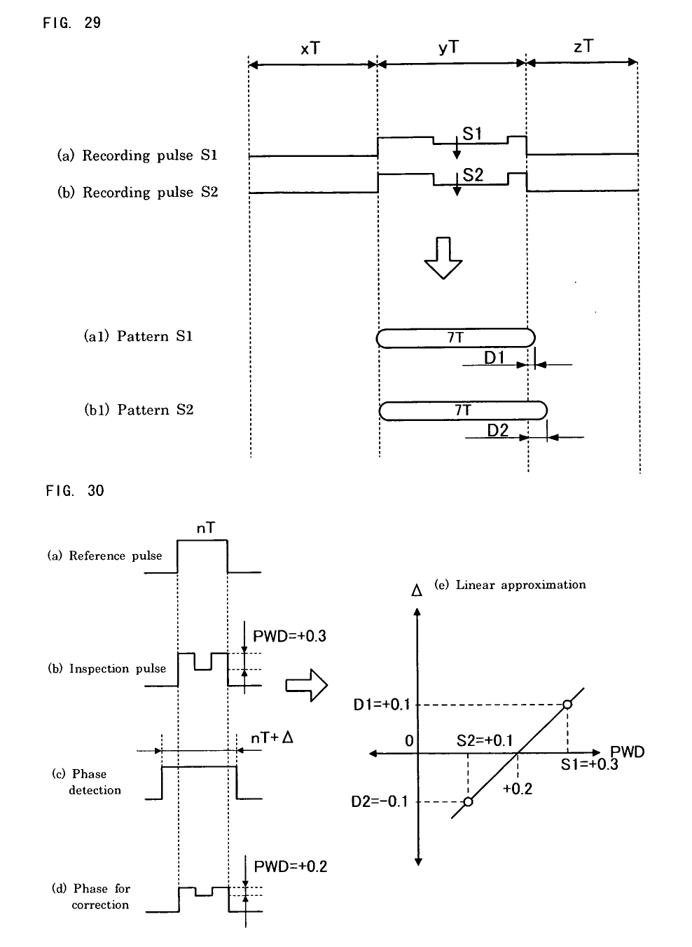

FIG. 29 is a conceptual diagram showing the relationship between the change in recording condition from S1 to S2 and the shift amount from D1 to D2 in case of changing PWD. The PWD of a recording pulse S1 shown in (a) is changed by an amount of S1 and the PWD of a recording pulse S2 shown in (b) by an amount of S2. Test recording is performed under the two recording conditions.

As a result of test recording, a pattern S1 shown in (a1) is obtained for the recording pulse S1 and a pattern S2 shown in (b1) is obtained for the recording pulse S2. A shift length of D1 occurs in the pattern S1 according to the control amount S1 and a shift length of D2 occurs in the pattern S2 according to the control amount S2.

If the values of the shift lengths D1 and D2 for the control amounts S1 and S2 are known, a shift length occurring from a control amount for any of the parameters can be predicted. Therefore, using the relationship between the change in control amount and the change in shift length, the prediction of a control amount and the determination of a correction value are performed.

FIG. 30 is a conceptual diagram showing an example of a shift length correction using a linear approximation in case of a single pulse. When determining a correction amount PWD for a shift length, the center part of a reference waveform nT having as a reference pulse length shown in (a) is transformed, that is, a height of the part is reduced by an amount of PWD as shown in (b), and then test recording is performed with the transformed waveform. As a result of test recording, the shift length Δ of the reproduced signal is detected as shown in (c).

Further, in the example shown in FIG. 30, two different shift lengths Δ are obtained as D1=+0.1 and D2=−0.1 for two different PWD values S1=+0.3 and S2=+0.1 respectively, and the relationship between the shift length Δ, that is, the control result, and the control amount PWD is obtained by a linear approximation using S1, S2, D1, and D2, as shown in (e). Then, by using the approximated line, a correction amount PWD=+0.2, which can cancel the shift length, is determined as the optimum correction amount. At this time, the condition of the top pulse is not changed, but fixed.

As such, the relationship between the change in strategy from S1 to S2 and the change in shift amount from D1 to D2 can be obtained by a linear or curve approximation if at least two points are obtained for each of the changes. Therefore, the optimum correction amount leading to a zero shift length can be obtained by using the approximated line or curve.

More specifically, some shift lengths D are first obtained while changing a strategy S. Next, by substituting the relationship between the strategy S and the shift amount D into a general expression ‘D=a×S+b’, simultaneous equations are obtained. By solving the simultaneous equations, constants a and b of the expression are calculated, resulting in obtaining an optimum strategy S for an ideal shift amount. Finally, by setting the optimum strategy S to the strategy circuit 102 shown in FIG. 2, the recording pulse can optimally be corrected.

For example, in case that a shift amount detected from a reproduced pattern for test recording with one strategy S1 and another shift amount detected from a reproduced pattern for test recording with another strategy S2 by the recording shift detection part 112 shown in FIG. 2 are D1 and D2 respectively, the following simultaneous equations are obtained:
D1=a×S1+b
D2=a×S2+b

From the above equations, the constants a and b are calculated and the following function using the constants a and b calculated is derived:
S=(D−b)/a

By substituting a value to improve recording quality, for example, the output shift amount D to correct for an initial output shift or the like occurring in an equalizer or the like, to the above function, the optimum strategy S can be determined.

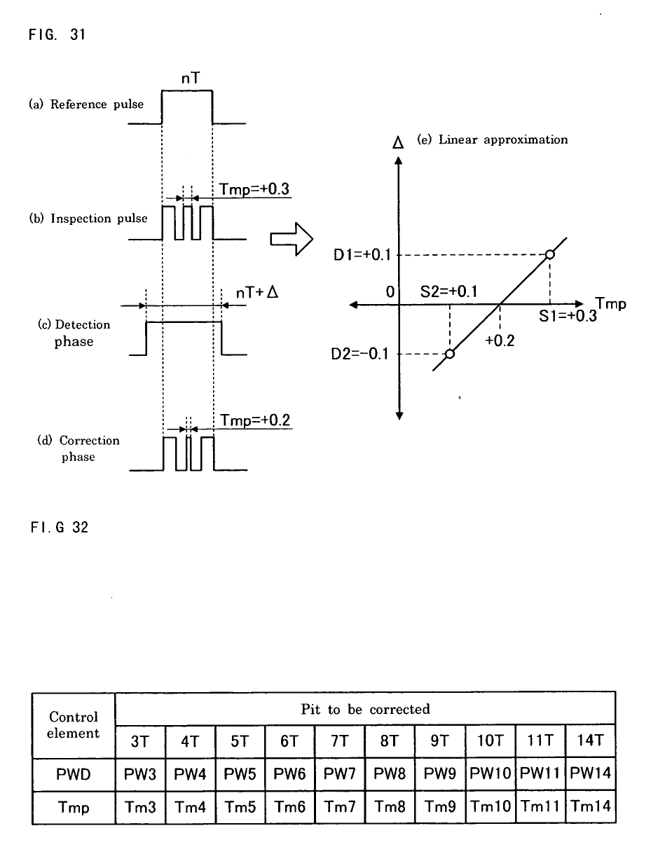

FIG. 31 is a conceptual diagram showing an example of a shift length correction using a linear approximation in case of a multi-pulse. When determining a correction amount Tmp for a shift length, a reference waveform nT having a reference pulse length shown in (a) is transformed so as to have an intermediate pulse with a pulse length Tmp as shown in (b), and test recording is performed with the transformed pulse. As a result of test recording, the shift length Δ of the reproduced signal is detected as shown in (c). At this time, the condition of a top pulse is not changed, but fixed.

Further, in the example shown in FIG. 31, two different shift lengths A are obtained as D1=+0.1 and D2=−0.1 for two different Tmp values S1=+0.3 and S2=+0.1 respectively, and the relationship between the shift length Δ, that is, the control result, and the control amount Tmp is obtained by a linear approximation using S1, S2, D1, and D2, as shown in (e). Then, by using the approximated line, a correction amount Tmp=+0.2, which can cancel a shift length, is determined as the optimum correction amount.

FIG. 32 is a conceptual diagram showing the configuration of a table for storing correction amounts PWD and Tmp. As shown in FIG. 32, the correction amounts PWD and Tmp are determined for each of pit lengths to be corrected. For example, in case that the pit to be corrected is 3T, correction amounts PWD and Tmp are stored in regions indicated by ‘PW3’ and ‘Tm3’ respectively in FIG. 32. Further, in each of other cases from 4T to 14T, correction amounts PWD and Tmp are stored in the same manner to the case of 3T.

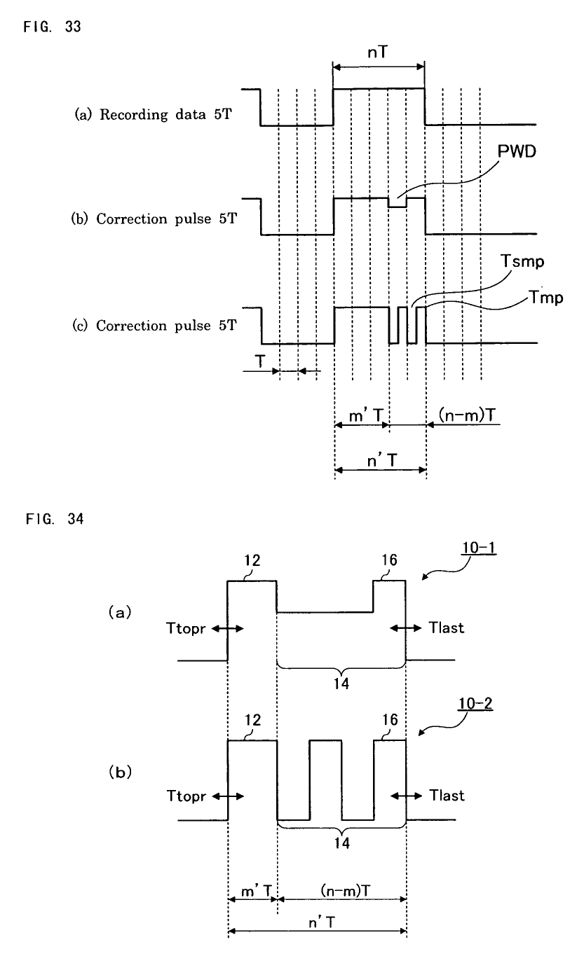

FIG. 33 is a conceptual diagram showing the configuration concept of an nT pulse to be executed at the step S300 in FIG. 1. For example, as shown in (a), recording data for forming a 5T pit is output as a pulse signal with a pulse length nT corresponding to the length of five cycles of a clock signal. A pulse for recording data after correction is output as a pulse signal with a length of n′T including a top pulse with a length of m′T as shown in (b) and (c). In case of a single pulse, PWD is defined within a (n−m)T part of the pulse signal as shown in (b). On the other hand, in case of a multi-pulse, Tmp is defined within a (n−m)T part of the pulse signal as shown in (c).

At this time, because PWD and Tmp have values obtained under the fixed top pulse condition, the values are with reference to an optimum m′T/(n−m)T ratio determined based on an mT pulse condition. Accordingly, the nT pulse having the top and following pulses is appropriate to improve recording quality. However, at this moment, a phase condition has not yet been determined, and therefore a phase condition determination flow to be described below is further performed to obtain the optimum strategy.

Correction for Phase Shift

FIGS. 34A and 34B are conceptual diagrams showing an example of a test recording pulse to be used for the phase shift correction at the step S400 shown in FIG. 1B. FIG. 34A shows an example of a case where a single pulse having a single pulse pattern is used, and FIG. 34B shows an example of a case where a multi-pulse having multiple pulses is used.

As shown in FIGS. 34A and 34B, in either case of the single pulse 10-1 or the multi-pulse 10-2, Ttopr for adjusting a start position of the top pulse 12 and Tlast for adjusting an end position of the back-end pulse 16 are set as a phase condition for the recording pulse. By adjusting these values, a pit length after recording is further optimized. Moreover, the phase condition is determined by performing test recording based on the top pulse and following pulse conditions determined by the preceding flow.

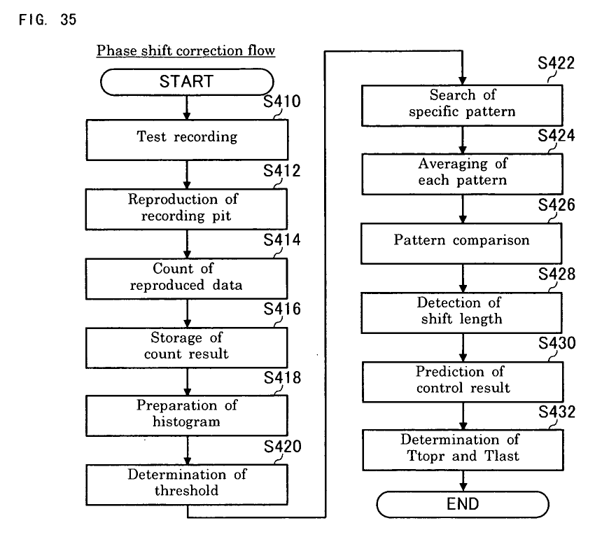

FIG. 35 is a flow chart showing an execution procedure of the phase condition determination flow at the step S400 shown in FIG. 1B. As shown in FIG. 35, test recording onto the medium 50 is first performed using the drive shown in FIG. 2 with a plurality of recording patterns having changed phase conditions for an nT pulse including an mT pulse and a (n−m)T pulse (Step S410). At this time, the mT pulse and (n−m)T pulse conditions are fixed to values obtained by the preceding flow.

Next, after the recorded pattern formed by the test recording is reproduced (Step S412), reproduced binarized signals obtained from the binarization circuit 110 as a result of the reproduction is counted by a counter, which is synchronized with a predetermined clock, in the recording shift detection part 112 (Step S414), and the lengths of pits and lands included in the reproduced binarized signals are stored in the storage region 115 as count data (Step S416).

Subsequently, the recording shift detection part 112 prepares a histogram representing an appearance frequency for every count by using count data stored in the storage region 115 (Step S418) and determines thresholds for count results that are to be reference for the length of pits and lands from the histogram (Step S420).

Subsequently, the recording shift detection part 112 searches various types of specific patterns including a specific pit/land pattern from count data stored in the storage region 115 using the thresholds as references (Step S422) and respectively calculates average lengths of pits and lands constituting the specific patterns by averaging count results considered to be for the same pit length included in the specific patterns and by averaging count results considered to be for the same land length (Step S424).

Subsequently, the recording shift detection part 112 sets one of various types of specific patterns extracted as a reference pattern, and compares the reference pattern with other patterns (Step S426) to independently detect each of the following shift amounts (Step S428):

(1) A phase shift amount on the front side of a pit relative to a recording pulse

(2) A phase shift amount on the rear side of a pit relative to a recording pulse

(3) A shift length of a pit relative to a recording pulse due to thermal interference.

Subsequently, the equation derivation part 113 derives an equation for determining an optimum strategy based on the shift amount detected by the recording shift detection part 112. Using the equation derived by the equation derivation part 113, the strategy determination part 114 predicts a control result for various parameters (Step S430). Further, in the strategy determination part 114, based on the prediction result, Ttopr and Tlast shown in FIGS. 34A and 34B are determined and then these values are set to the strategy circuit 102 (Step S432).

Several steps of the flow shown in FIG. 35 from the test recording step S410 to the averaging step S424 are not described in detail because these steps are performed in the same manner to the procedure shown in FIGS. 20 to 24.

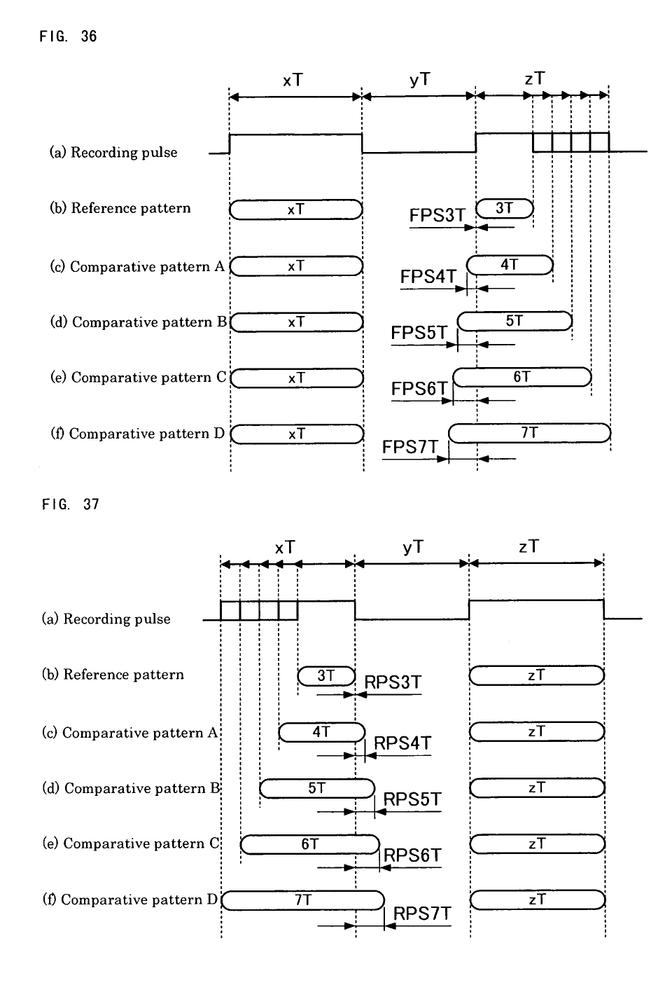

FIG. 36 is a conceptual diagram an example of a recording pattern and a reproduced pattern to detect a phase shift amount on the front side of each pit length. As shown in FIG. 36, when detecting a phase shift amount on the front side of each pit length, test recording is performed with a recording pulse shown in (a). The recording pulse includes a pattern successively having a fixed pit PxT, a fixed land LyT, and a variable pit PzT. Here, a pit length of the fixed pit PxT and a land length of the fixed land LyT are fixed, while a pit length of the variable pit PzT is changed from 3T to 7T as shown in (b) to (f). Moreover, though not shown, the pit length of the variable pit PzT is changed to 14T.

If the length of the fixed land LyT in each of the recording patterns is measured, the length should be constant in an ideal recording condition. However, in case that the length of the fixed land LyT is shifted relative to a predetermined length, the shift length relative to the predetermined length corresponds to the phase shift amount on the front side of each of the pits P3T to P14T corresponding to 3T to 14T of recording pulses generated with a strategy during recording because the length of the fixed pit PxT is fixed.

Accordingly, by comparing the length of a fixed land LyT in a reference pattern with a length of a fixed land LyT in each comparative pattern, the phase shift amount on the front side of the each comparative pattern relative to the reference pattern can be obtained as FPS4T, FPS5T, FPS6T or FPS7T. Here, the reference pattern means a pattern in which the length of the variable pit PzT is 3T as shown in (b) and the comparative pattern means any of the other patterns as shown in (c) to (f).

The phase shift amount FPS3T, FPS4T, FPS5T, FPS6T or FPS7T may be detected as a relative value based on a certain part, and therefore a phase shift amount on the front side of the reference pattern FTS3T may be defined as zero or as a shift amount relative to an ideal length. Further, any one of the patterns shown in (c) to (f) may be defined as a reference pattern instead of the pattern shown in (b).

FIG. 37 is a conceptual diagram showing an example of a recording pattern and a reproduced pattern to detect a phase shift amount on the rear side of each pit length. As shown in FIG. 37, when detecting a phase shift amount on the rear side of each pit length, test recording is performed with a recording pulse shown in (a). The recording pulse includes a pattern successively having a variable pit PxT, a fixed land LyT, and a fixed pit PzT. Here, a land length of the fixed land LyT and a pit length of the fixed pit PzT are fixed, while a pit length of the variable pit PxT is changed from 3T to 7T as shown in (b) to (f). Moreover, though not shown, the pit length of the variable pit PxT is changed up to 14T.

If the length of the fixed land LyT in each of the recording patterns is measured, the length should be constant in an ideal recording condition. However, in case that the length of the fixed land LyT is shifted relative to a predetermined length, the shift length relative to the predetermined length corresponds to a phase shift amount on the rear side of each of the pits P3T to P14T corresponding to 3T to 14T of recording pulses generated with a strategy during recording because the length of the pit PzT is fixed.

Accordingly, by comparing the length of a fixed land LyT in a reference pattern with a length of a fixed land LyT in each comparative pattern, the phase shift amount on the rear side of the each comparative pattern relative to the reference pattern can be obtained as RPS4T, RPS5T, RPS6T or RPS7T. Here, the reference pattern means a pattern in which a length of the variable pit PxT is 3T as shown in (b) and the comparative pattern means any of the other patterns as shown in (c) to (f).

The phase shift amount RPS3T, RPS4T, RPS5T, RPS6T or RPS7T may be detected as a relative value based on a certain part, and therefore a phase shift amount on the rear side of the reference pattern RTS3T may be defined as zero or as a shift amount relative to an ideal length. Further, any one of the patterns shown in (c) to (f) may be defined as a reference pattern instead of the pattern shown in (b).

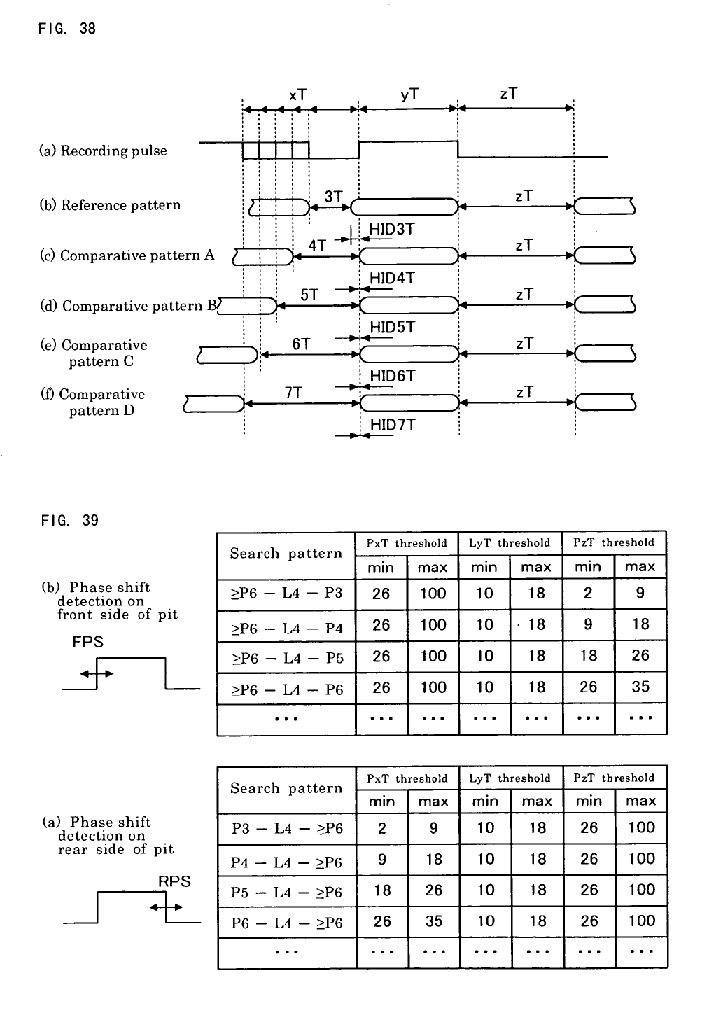

FIG. 38 is a conceptual diagram showing an example of a recording pattern to detect a shift length of each pit due to thermal interference. As shown in FIG. 38, when detecting a shift length of the each pit, test recording is performed with a recording pulse shown in (a). The recording pulse includes a pattern successively having a land LxT, a pit PyT, and a land LzT. Here, a pit length of the fixed pit PyT and a land length of the fixed land LzT are fixed, while a land length of the variable land LxT is changed from 3T to 7T as shown in (b) to (f). Moreover, though not shown, the land length of the variable land LxT is changed up to 14T.

If the length of the fixed pit PyT in each of the recording patterns is measured, the length should be constant in an ideal recording condition. However, in case that the length of the fixed pit PyT is shifted relative to a predetermined length, the shift length relative to the predetermined length corresponds to a shift length due to thermal interference occurring from a pit formed immediately before the each variable land LxT because the length of the land LzT is fixed.

Accordingly, by comparing the length of a fixed pit PyT in a reference pattern with the length of a fixed pit PyT in each comparative pattern, the shift amount on the front side of the each comparative pattern relative to the reference pattern can be obtained as HID3T, HID4T, HID5T, HID 6T or HID7T. Here, the reference pattern means a pattern in which the length of the variable land LxT is 3T as shown in (b) and the comparative pattern means any of the other patterns as shown in (c) to (f).

The shift amount HID3T, HID4T, HID5T, HID 6T or HID7T may be detected as a relative value based on a certain part, and therefore a shift amount on the front side of the reference pattern HID3T may be defined as zero or as a shift amount relative to an ideal length. Further, any one of the patterns shown in (c) to (f) may be defined as a reference pattern instead of the pattern shown in (b).

FIGS. 39A and 39B are conceptual diagrams showing the configuration of a table for searching specific patterns to be used for the detection of a phase shift on the front side of a pit and for the detection of a phase shift on the rear side of a pit. In case of the detection of a phase shift on the front side of a pit, based on a set of threshold ranges for a pit PxT, a land LyT, and a pit PzT prepared for each specific pattern shown in (a), data stored in the storage region 115 in FIG. 2 are searched (equivalent to the step S422 in FIG. 35), resulting in the extraction of a data row meeting the threshold ranges.

Subsequently, count results corresponding to the pit PxT, the land LyT, and the pit PzT are sorted and averaged (equivalent to the step S424 in FIG. 35). By performing the above-described pattern comparison using the averaged values of the count results, a phase shift amount on the front side of each pit can be obtained. FIG. 39B shows an example of a threshold in case of the detection of a phase shift on the rear side of a pit, and the organization and operation are same as the case of the detection of a phase shift on the front side of a pit.

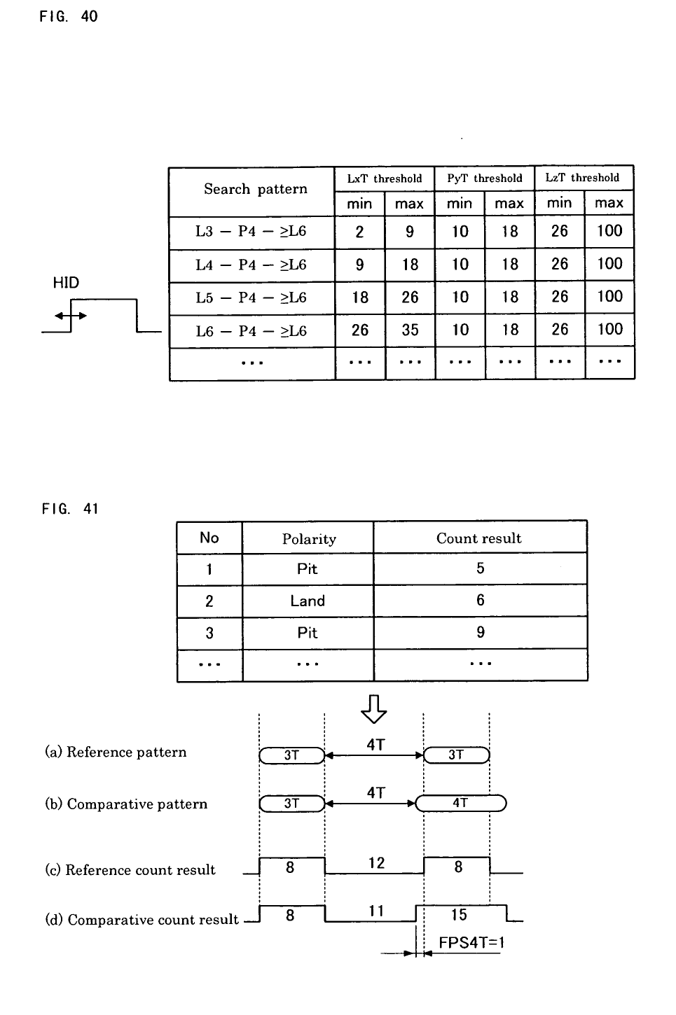

FIG. 40 is a conceptual diagram showing the configuration of a table for searching specific patterns to be used for detecting a pit interference shift. As shown in FIG. 40, the detection of a pit interference shift is performed in the same manner as the detection of a phase shift on the front or rear side of a pit described above with reference to FIG. 39.

FIG. 41 is a conceptual diagram showing a specific example of a case where a shift amount is detected by the relative comparison of count results. FIG. 41 shows an example of a case where a phase shift on the front side of a pit is detected. However, the detection of any other shift amount is also performed in the same manner. When detecting a shift amount, a reference pattern and a comparative pattern shown in (a) and (b) respectively are first searched and extracted from a group of data stored in the storage region. Next, as shown in (c) and (d), two count values are compared with each other for a part which should essentially have a fixed length. In the example shown in FIG. 41, because a land LyT is a comparative part, a difference between a count ‘12’ for the reference pattern shown in (c) and a count ‘11’ for the comparative pattern shown in (d) is obtained, and consequently a shift amount FPS4T can be obtained as the difference ‘1’.

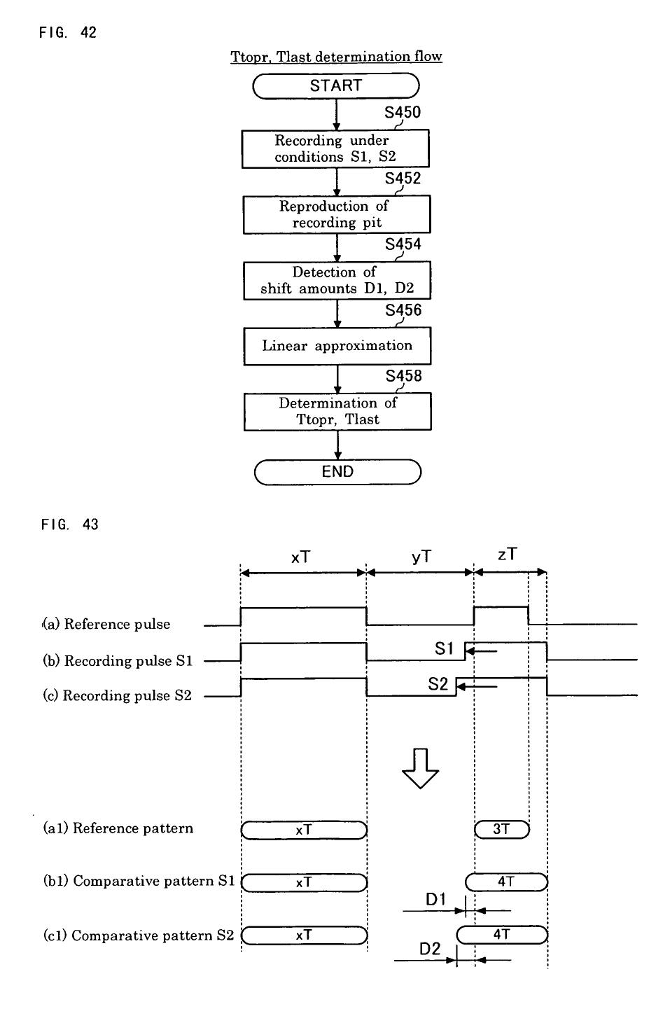

FIG. 42 is a flow chart showing an execution procedure of the determination of Ttopr or Tlast by the prediction of a control amount shown in FIG. 35. As shown in FIG. 42, the prediction of a control amount is performed in such a manner that test recording is first performed under at least two different conditions S1 and S2 (Step S450), the recording pits are reproduced (Step S452), a shift amount D1 for the condition S1 and a shift amount D2 for the condition S2 are obtained by comparing the reproduced patterns (Step S454), the relationship between (S1, D1) and (S2, D2) is linearly approximated (Step S456), and then an optimum Ttopr or Tlast is finally determined by using the approximated line (Step S458).

FIG. 43 is a conceptual diagram showing the relationship between the change in recording condition from S1 to S2 and the shift amount from D1 to D2. A recording pulse shown in (a) is used as a reference pulse having ‘PzT=3T’, and recording pulses S1 and S2, of which front edges of PzTs are shifted by amounts of S1 and S2 respectively as shown in (b) and (c), are used as comparative recording pulses having ‘PzT=4T’. And then, test recording is performed using these recording pulses.

As a result of test recording, a reference pattern shown in (a1) is obtained for the recording pulse shown in (a), a comparative pattern S1 shown in (b1) is obtained for the recording pulse shown in (b), and a comparative pattern S2 shown in (c1) is obtained for the recording pulse shown in (c). Here, a shift amount D1 occurs in the comparative pattern S1 from the control amount of S1 and a shift amount D2 occurs in the comparative pattern S2 from the control amount S2.

If the values of the shift amounts D1 and D2 for the control amounts S1 and S2 are known, the relationship between a shift amount and a control amount for any of the parameters can be predicted. Therefore, using the relationship between the change in control amount and the shift amount, the prediction of a control amount and the determination of a correction value are performed.

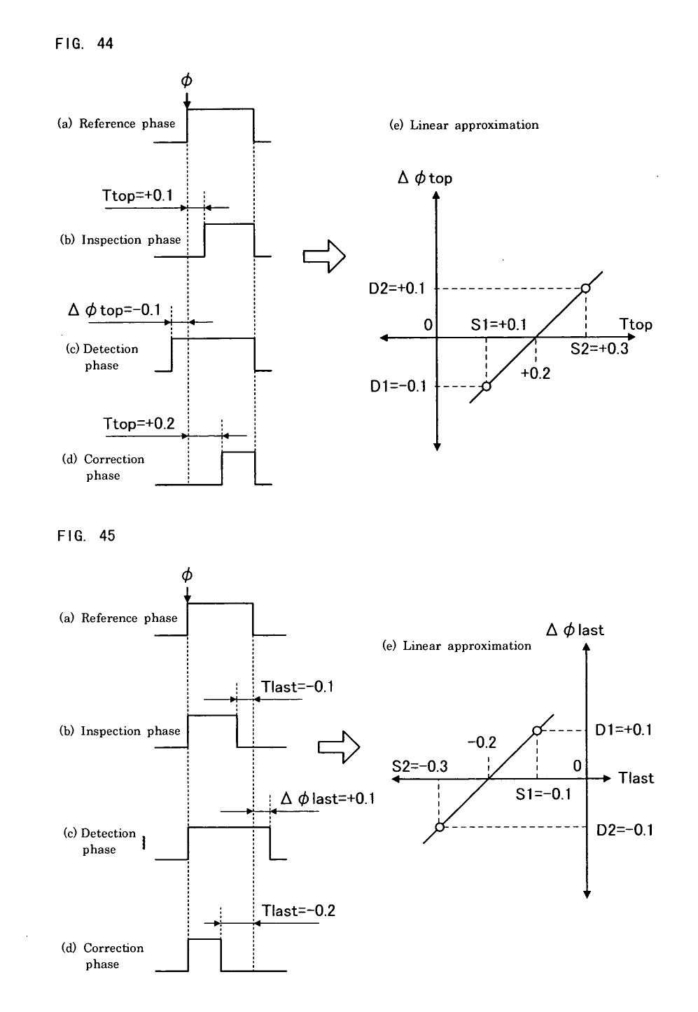

FIG. 44 is a conceptual diagram showing an example of a correction for a phase shift on the front side of a pit using a linear approximation. When determining a correction amount Ttop for a phase shift on the front side of a pit, test recording is performed with a pulse having a top position shifted by an amount of Ttop as shown in (b) relative to a reference phase φ shown in (a), which is a reference pulse position (equivalent to a test condition S1 or S2). As a result of test recording, a phase shift Δφtop of the reproduced signal is detected as shown in (c) (equivalent to a shift amount D1 or D2).

In the example shown in FIG. 44, two different phase shift amounts Δφtop are obtained as D1=−0.1 and D2=+0.1 for two different Ttop values S1=+0.1 and S2=+0.3 respectively, and therefore the relationship between the phase shift amount Δφtop, i.e., the control results, and the control amount Ttop can be obtained by a linear approximation using S1, S2, D1 and D2. As a result, by using the approximated line, a correction amount of Ttop=+0.2, which can cancel a phase shift, can be determined as an optimum correction amount.

As such, the relationship between the change in strategy from S1 to S2 and the change in shift amount from D1 to D2 can be obtained by a linear or curve approximation if at least two different points are obtained for each of the changes. Therefore, an optimum correction amount leading to a zero shift amount can be obtained by using the approximated line or curve.

More specifically, some shift amounts D are first obtained while changing a strategy S. Next, by substituting the relationship between the strategy S and the shift amount D at that time into a general expression ‘D=a×S+b’, simultaneous equations are obtained. By solving the simultaneous equations, constants a and b in the expression are calculated, resulting in obtaining an optimum strategy S for an ideal shift amount D. Finally, by setting the optimum strategy S to the strategy circuit 102 shown in FIG. 1, a recording pulse can optimally be corrected.

For example, in case that a shift amount detected from a reproduced pattern for test recording with one strategy S1 and another shift amount detected from a reproduced pattern for test recording with another strategy S2 by the recording shift detection part 112 shown in FIG. 1 are D1 and D2 respectively, the following simultaneous equations are obtained:
D1=a×S1+b
D2=a×S2+b

From the above equations, constants a and b are calculated and the following function using the constants a and b calculated is derived:
S=(D−b)/a

By substituting a value to improve recording quality, for example, an output shift amount D to correct for an initial output shift or the like occurring in an equalizer or the like, into the above function, an optimum strategy S can be determined.

Moreover, the function to obtain an optimum strategy S may be derived for each of the pits P3T, P4T, . . . and P14T corresponding to 3T, 4T, . . . and 14T respectively. Further, the function to obtain an optimum strategy S may be derived for each recording rate.

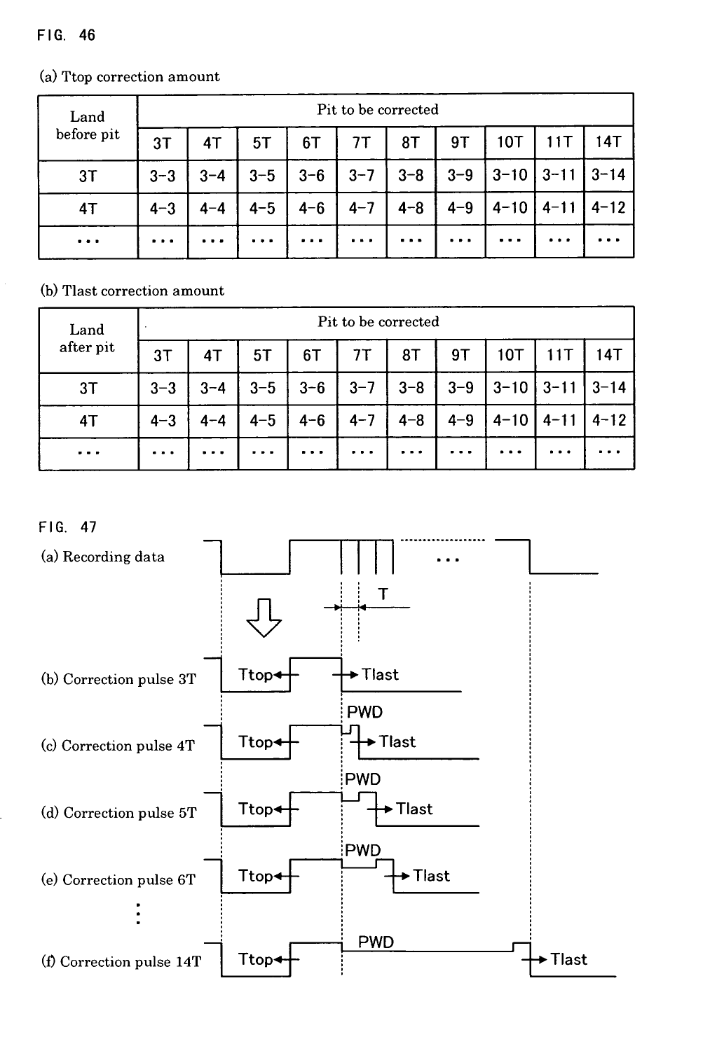

FIG. 45 is a conceptual diagram showing an example of a correction for a phase shift on the rear side of a pit using a linear approximation. When determining a correction amount Tlast for a phase shift on the rear side of a pit, test recording is performed with a pulse having an end position shifted by an amount of Tlast as shown in (b) relative to a out according to a land length immediately before the pit from the table shown in FIG. 46 and a rear side correction value Tlast for the 3T pit is read out according to a land length immediately after the pit. Next, the front side and the rear side of the recording pulse are corrected using the Ttop and the Tlast respectively.

In case of the correction for a pit having a length equal to 4T or more, a PWD correction value for the length of the pit is read out from the table shown in FIG. 32 in addition to Ttop and Tlast. Next, a shape of the pulse is corrected according to the PWD value as shown in (c) to (f).

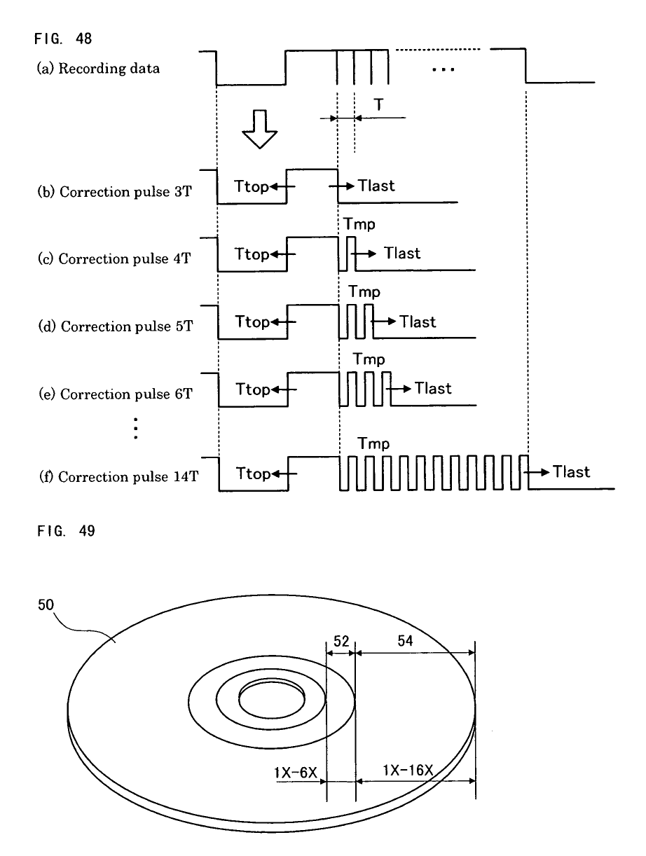

FIG. 48 is a conceptual diagram showing examples of multi-pulses after corrections. As shown in FIG. 48, in case of a multi-pulse, a Tmp correction value is read out from the table shown in FIG. 32, instead of a PWD correction value in case of the above-described single pulse shown in FIG. 47, and then a shape of the multi-pulse is corrected according to the Tmp value as shown in (c) to (f). The other corrections are performed in the same manner as the single pulse case.

Moreover, in the embodiments described above, an optimum strategy S is determined by substituting a shift amount D into a function for obtaining the optimum strategy S. However, the strategy S may be determined based on a correction table obtained using the function.

The above optimum strategy S may be set whenever the type of an optical disc is changed or a recording rate is changed. Further, an optimum strategy condition set above may be stored in a memory for every optical disc type or for every recording rate, and then the optimum strategy may be read out from the memory and used when recording is performed with the optical disc type or recording is performed with the recording rate.

FIG. 49 is a conceptual diagram showing the relationship between inner and outer circumferences of a medium and an executable recording rate. As shown in FIG. 49, the medium 50 has a test region 52 provided on the inner circumference side and a recording region 54 provided from the inner circumference to the outer circumference. When determining the recording condition, test recording is performed within the test region 52 provided on the inner circumference side. reference phase φ shown in (a), which is a reference pulse position. As a result of test recording, a phase shift Δφlast of the reproduced signal is detected as shown in (c).

In the example shown in FIG. 45, two different phase shift amounts Δφlast are obtained as D1=+0.1 and D2=−0.1 for two different Tlast values S1=−0.1 and S2=−0.3 respectively, and the relationship between the phase shift amount Δφlast, i.e., the control result, and the control amount Tlast can be obtained by a linear approximation using S1, S2, D1, and D2 as shown in (e). As a result, by using the approximated line, a correction amount Tlast=−0.2, which can cancel a phase shift, can be determined as an optimum correction amount.

FIGS. 46A and 46B are conceptual diagrams showing the configuration of a table for storing correction amounts Ttop and Tlast. As shown in FIG. 46A, the correction amount Ttop is determined for the length of each pit to be corrected in combination with the length of a land immediately before the pit. For example, in case that the length of a pit to be corrected is 3T and the length of a land immediately before the pit is 3T, a correction amount is stored in the region indicated by ‘3-3’ in FIG. 46A. Similarly, a correction amount is stored in the region indicated by ‘3-4’ in case that the length of a pit to be corrected is 4T and the length of a land immediately before the pit is 3T. In any other case of 5T to 14T, a correction amount is stored in the same manner as the case of 3T or 4T.

Further, as shown in FIG. 46B, the correction amount Tlast is determined for the length of each pit to be corrected in combination with the length of a land immediately after the pit. For example, in case that the length of a pit to be corrected is 3T and the length of a land immediately after the pit is 3T, a correction amount is stored in the region indicated by ‘3-3’ in FIG. 46B. Similarly, a correction amount is stored in the region indicated by ‘3-4’ in case that the length of a pit to be corrected is 4T and the length of a land immediately after the pit is 3T. In any other case of 5T to 14T, a correction amount is stored in the same manner as the case of 3T or 4T.

FIG. 47 is a conceptual diagram showing examples of single pulses after corrections. When recording data shown in (a) is recorded onto an optical disc, a strategy is set. Here, an optimum correction value is applied to each pit length. For example, in case of recording a 3T pit, as shown in (b), a front side correction value Ttop for the 3T pit is read

Here, a difference between an allowable recording rate on the inner circumference side and an allowable recording rate on the outer circumference side occurs due to the rotation limitation of a spindle motor or the like. For example, in case of DVD-R, 16× recording can be performed on the outermost circumference with ability of a current spindle motor. On the other hand, in the test region 52 provided on the inner circumference, 6× recording is performed at the utmost.

Accordingly, as shown in FIG. 49, in the test region 52, executable rates are 1× to 6×, while executable rates are 1× to 16× in the recording region 54. As described above, however, the setting condition of the strategy is determined by test recording, and thus just the condition to 6× can be measured. Therefore, in one embodiment, there is provided a method for setting a recording condition relative to high-speed recording which cannot be performed in the test region.

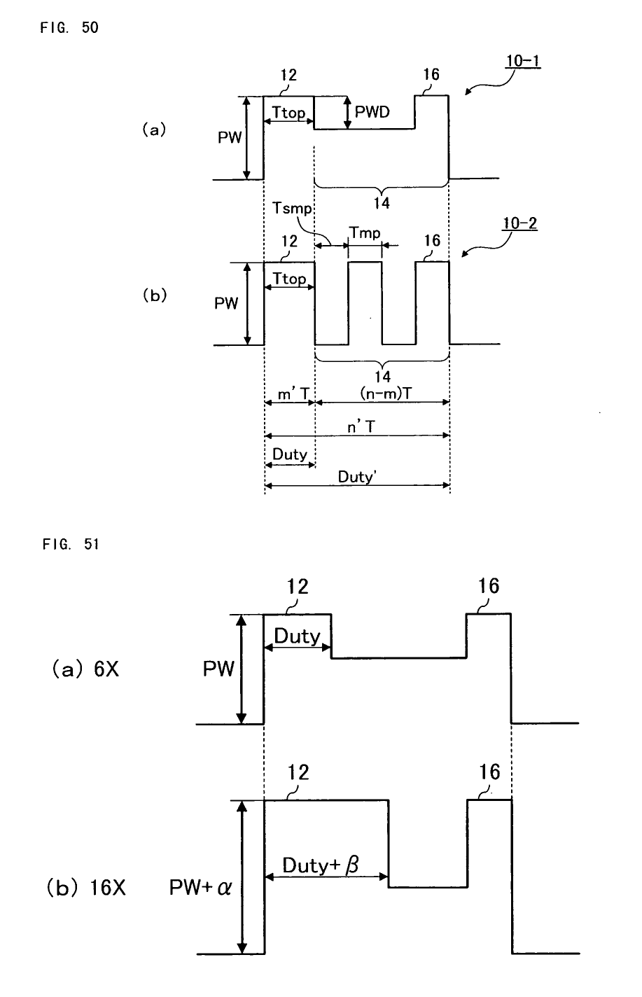

FIGS. 50A and 50B are conceptual diagrams showing an example of the configuration when the recording pulses shown in FIGS. 18A and 18B are applied to high-speed recording. In case of high-speed recording, through the control of a power PW and a duty shown in FIGS. 50A and 50B, high-speed recording is maintained within the upper limit of the power of the laser oscillator 103 shown in FIG. 2 without causing the reduction in recording rate as much as possible.

Here, as shown in FIGS. 50A and 50B, the duty of the recording pulse may be defined with a length indicated by ‘Duty’ in the drawing which is defined with the length of the top pulse width Ttop or may be defined with a length indicated by ‘Duty” in the drawing which is defined with the entire length of the recording pulse.

As described above, the energy amount of the entire recording pulse is defined with the height indicated by the main power PW, and the energy amount of the initial stage which is provided to the front edge of a recording pit is defined with the length indicated by the top pulse width Ttop. Therefore, in case that the main power PW tends to exceed the upper limit of the power of the laser oscillator 103 with the improvement of the recording rate, the length of the top pulse width Ttop is increased while the power within the upper limit is suppressed. As a result, an energy amount required for high-speed recording can be ensured.

The top pulse width Ttop has a width corresponding to the shortest recording pit having the length of 3T. The shortest recording pulse has the highest appearance probability and significantly influences recording quality. Therefore, when increasing the duty of the recording pulse, the length of the top pulse width Ttop is first increased. When the increase in length of the top pulse width Ttop is still insufficient, the length of the entire recording pulse is increased.

FIGS. 51A and 51B are conceptual diagrams showing a concept for obtaining a duty defined by a power and a length of a top pulse in case of high-speed recording having a difficulty in test recording, by using a power and a duty obtained with low-speed recording where test recording can be performed. As shown in FIG. 51A, for example, in case that test recording is actually performed at a recording rate of 6× where test recording can be performed, and the conditions obtained as a result of test recording are the power PW and the duty as shown in FIG. 51A, a power and a duty for a recording rate of 16× having a difficulty in test recording can be obtained by adding α and β to the conditions obtained at 6×, respectively.

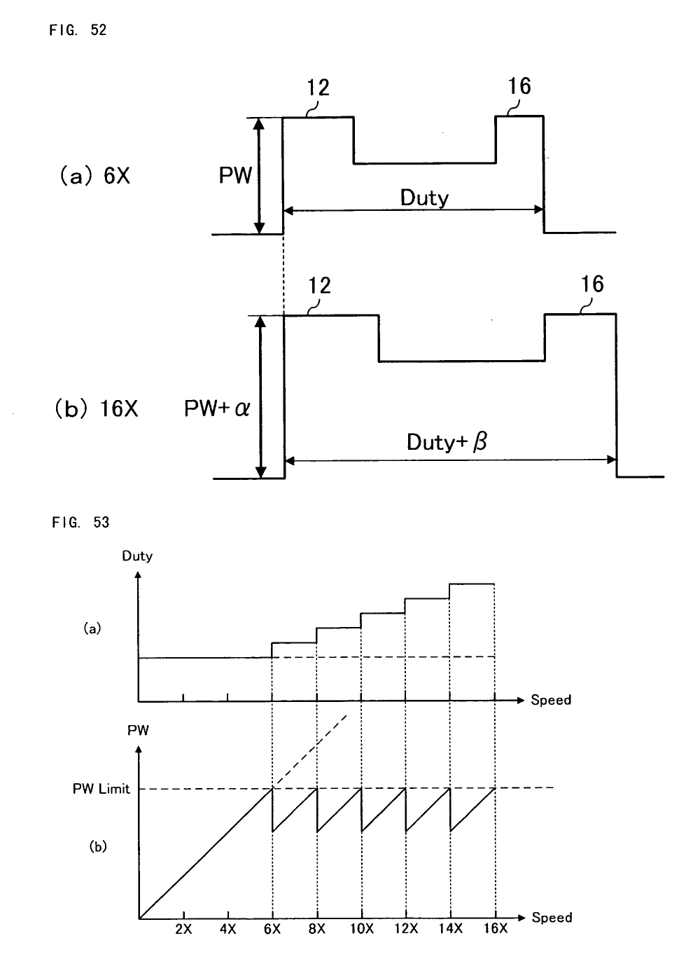

FIGS. 52A and 52B are conceptual diagrams showing a concept for obtaining a duty defined by a power and a length of a recording pulse in case of high-speed recording having a difficulty in test recording, by using a power and a duty obtained with low-speed recording where test recording can be performed. As shown in FIGS. 52A and 52B, the duty of the recording pulse may be defined by the length of the entire recording pulse.

FIGS. 53A and 53B are conceptual diagrams showing a first method for predicting a power and a duty in case of a low speed having a difficulty in test recording, from conditions of a power and a duty obtained by test recording. FIG. 53A shows a change in duty relative to an increase in recording rate, and FIG. 53B shows a change in power relative to an increase in recording rate.

As shown in FIG. 53B, when increasing the recording rate, an increase in power is required with the increase in rate. However, it is not preferable to use a power which is more than the upper limit of the power of the laser oscillator indicated by a dotted line in the drawing. Therefore, when the power is expected to exceed the upper limit, the power condition is reduced, and the duty is increased by the reduction amount of the power as shown in FIG. 53A.

For example, as shown in FIG. 53B, when the optimum power is obtained at each rate by 4× and 6× test recording, an increase slope of a power relative to a recording rate becomes a slope indicated by a solid line in the drawing. Therefore, the power conditions of 8× or more having a difficulty in test recording can be obtained by using an extension line having a slope indicated by a dotted line in the drawing. Further, as shown in FIG. 53B, when the power obtained by using the extension line exceeds the upper limit of the power of the laser oscillator, the power condition for the recording rate is set to be equal to or less than the upper limit of the power of the laser oscillator, and the required energy amount is ensured by increasing the duty as shown in FIG. 53A.

Moreover, when increasing the duty, a duty after the increase is determined by adding a required amount with a duty of a recording rate capable of test recording indicated by a dotted line in FIG. 53A as the reference. As such, when the power is expected to exceed the upper limit, the power is reduced and the duty is increased, thereby expanding the maximum recording rate.

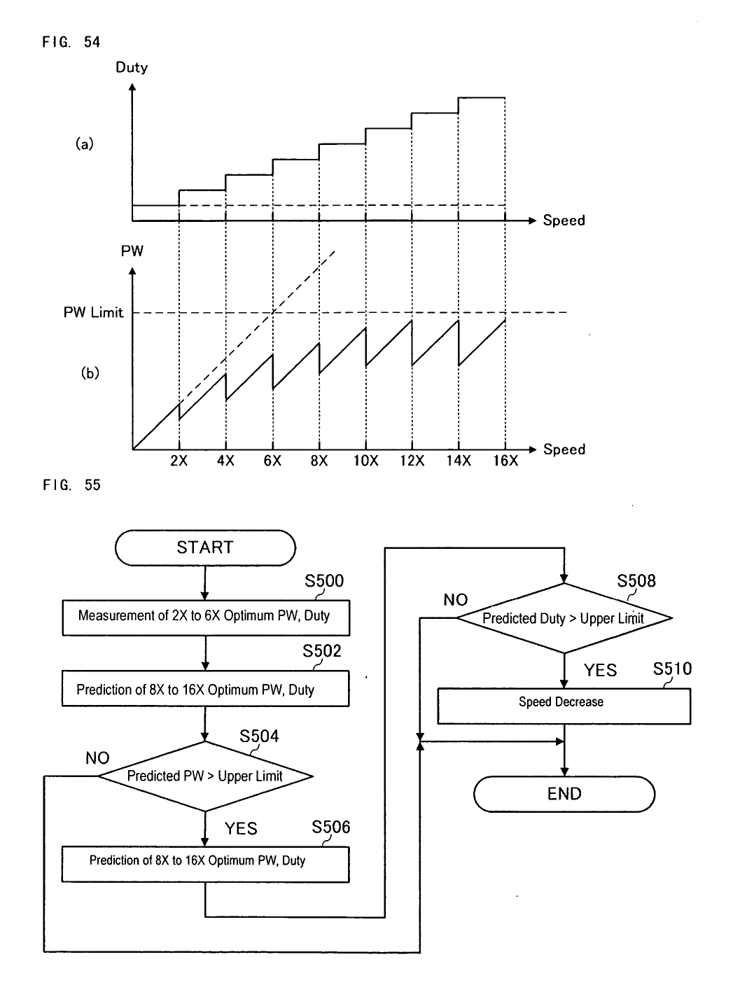

FIGS. 54A and 54B are conceptual diagrams showing a second method for predicting a power and a duty in case of a low speed having a difficulty in test recording, from conditions of a power and a duty obtained by test recording. FIG. 54A shows a change in duty relative to an increase in recording rate, and FIG. 54B shows a change in power relative to an increase in recording rate.

A method shown in each of FIGS. 54A and 54B is an example of a case where the duty condition is set to be gradually increased with the increase in recording rate for every recording rate, and the power condition for high-speed recording is predicted by using the set duty condition.

In this method, regardless of whether or not the power reaches the upper limit of the laser output, the duty condition is increased with the increase in recording rate, thereby expanding the maximum recording rate with a power equal to or less than the upper limit of the laser output.

FIG. 55 is a flow chart showing a first execution procedure for predicting a power and a duty for a rate having a difficulty in test recording, from conditions of a power and a duty obtained by test recording. As shown in FIG. 55, when setting a high-speed recording condition having a difficulty in measuring with the test region by this procedure, test recording is first performed at a rate from 2× to 6× capable of test recording or plural arbitrary rates by using the test region of the medium to be recorded, thereby setting the power and the duty for every rate (Step S500).

Next, the power and duty for every rate of 8× to 16× having a difficulty in executing with the test region are predicted by using change coefficients of the power and the duty of 2× to 6× obtained by test recording (Step s502).

Next, when the predicted power exceeds the upper limit of the laser oscillator (YES at the step S504), the power for the recording rate is reduced, and the duty for the recording rate is increased (Step S506). On the other hand, when the predicted power is equal to or less than the upper limit of the laser oscillator (NO at the step S504), the power is determined as the condition for the recording rate, and then the process ends.

Subsequently, when the duty increased at the step S506 exceeds the upper limit of the duty (YES at the step S508), the recording rate is reduced, and then recording is performed under a condition meeting the upper limit of the power and the upper limit of the duty (Step S510). Here, the upper limit of the duty includes a value which is previously set for every mark length as an allowable duty having influence on the identification of the mark length. On the other hand, when the increased duty is equal to or less than the upper limit (NO at the step S508), the duty is determined for the recording rate, and then the process ends.

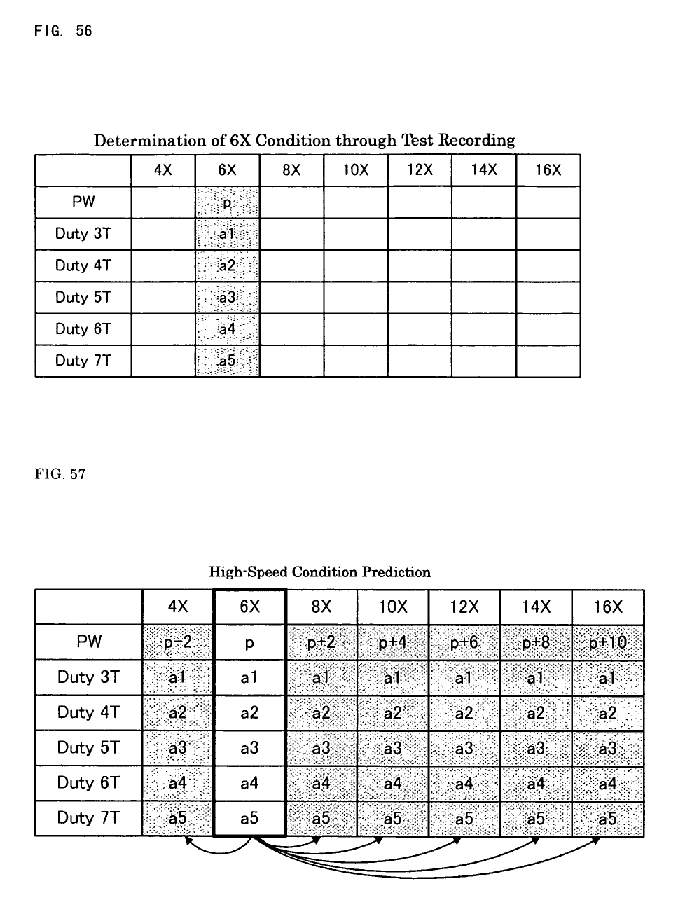

FIG. 56 is a data diagram showing an execution example of the step S500 shown in FIG. 55. As shown in FIG. 56, a rate capable of recording by use of the test region, for example, the power PW for 6× and the duty Duty3T to Duty7T for each mark length are first measured. The optimum power value p1 and the optimum duty values a1 to a5 obtained as a result of the measurement are stored in a memory of a drive.

FIG. 57 is a data diagram showing an execution example of the step S502 shown in FIG. 55. As shown in FIG. 57, after the measurement of the optimum condition for 6×, the energy amount required for each rate is added or subtracted based on the 6× condition so as to predict the recording condition for each rate.

For example, the power of 4× is set to be lower than the power of 6×. Accordingly, when the power of 6× is p, the power of 4× is set to a power obtained by subtracting the coefficient 2 from the power of 6×. Further, because the power of 8× is set to be higher than the power of 6×, the power of 8× is set to a power obtained by adding 2 to the power p of 6×. Moreover, the duty condition for each rate is set to a value obtained for 6×.

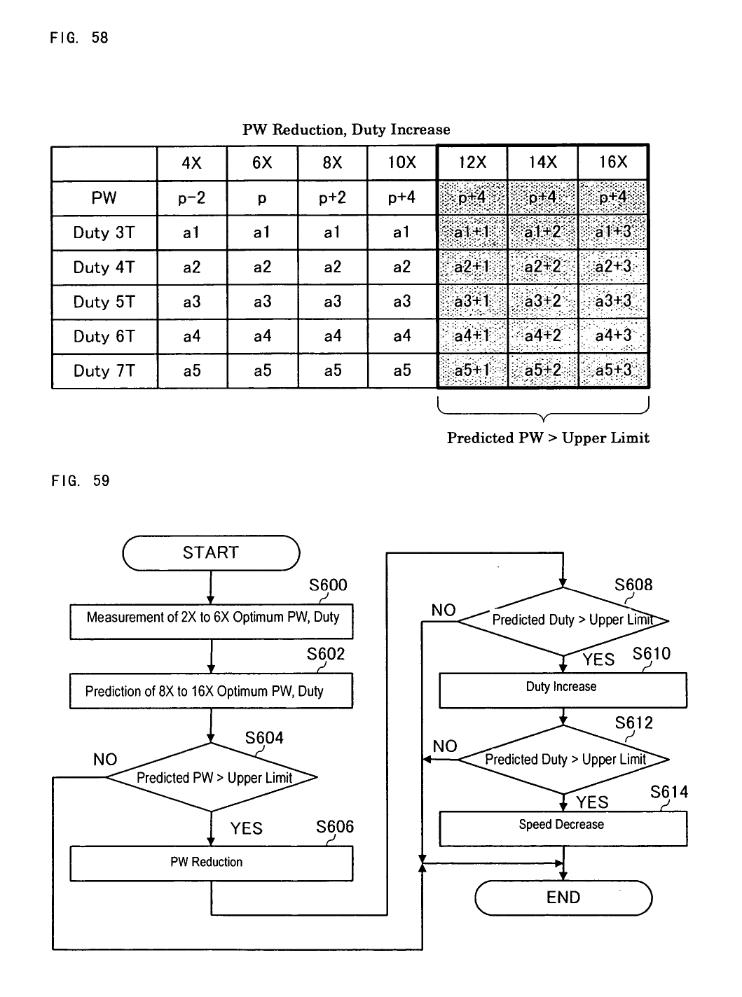

FIG. 58 is a data diagram showing an execution example of the steps S504 and S506 shown in FIG. 55. As shown in FIG. 58, when the power of 12× or more predicted by the above-described procedure exceeds the upper limit p+4 of the laser oscillator, the prediction power of 12× or more is reduced to p+4, and the duty condition for a rate having a reduced power is increased according to a rate increase ratio. FIG. 59 is a flow chart showing a second execution procedure for predicting a power and a duty for a rate having a difficulty in test recording, from conditions of a power and a duty obtained by test recording. As shown in FIG. 59, when setting the high-speed recording condition which cannot be measured in the test region by this procedure, test recording is first performed at a rate of 2× to 6× capable of test recording or at plural arbitrary rates by using the test region of the medium to be recorded, thereby setting the power and the duty for each rate (Step S600).

Next, the power and the duty for each rate from 8× to 16× having a difficulty in executing with the test region are predicted by using the change coefficient of the power and the duty for 2× to 6× obtained by test recording (Step S602).

Next, when the predicted power exceeds the upper limit of the laser oscillator (YES at the step S604), the power for the recording rate is reduced (Step S606). On the other hand, the predicted power is equal to or less than the upper limit of the laser oscillator (NO at the step S604), the power is determined as the condition for the recording rate, and then the process ends.

Subsequently, when the power increased at the step S606 still exceeds the upper limit of the power (YES at the step S608), the duty is increased (Step S610).

Subsequently, when the duty increased at the step S610 exceeds the upper limit of the duty (YES at the step S612), the recording rate is reduced, and thus recording is performed under a condition meeting the upper limit of the power and the upper limit of the duty (Step S614). On the other hand, when the increased duty is equal to or less than the upper limit of the duty (NO at the step S612), the duty is determined as a condition for the recording rate, and then the process ends.

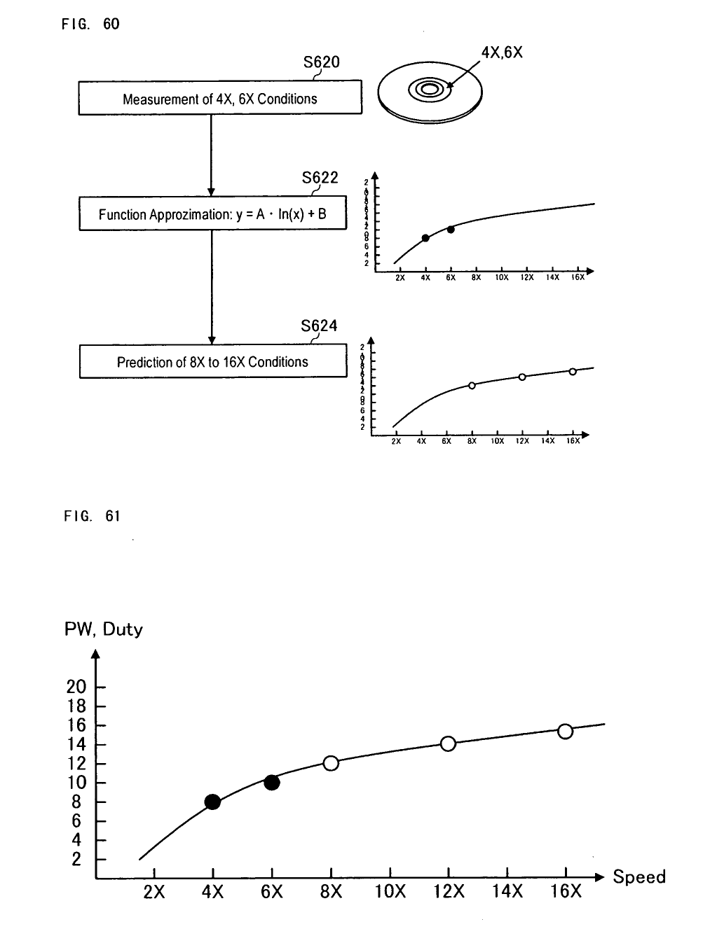

FIG. 60 is a flow chart showing a third execution procedure for predicting a power and a duty for a rate having a difficulty in test recording, from conditions of a power and a duty obtained by test recording. As shown in FIG. 60, when setting the high-speed recording condition which cannot be measured in the test region by this procedure, the optimum power and duty are calculated by test recording using at least two recording rates to be executable with the test region, for example, 4× and 6× (Step S620).

Subsequently, a function approximation is performed by using the power and the duty at the two points (Step S622), and the power and the duty for a rate having a difficulty in measuring with the test region, for example, up to 8× to 16×, are predicted by using the approximated function (Step S624).

FIG. 61 is a data diagram showing an execution example of the steps S622 and S624 shown in FIG. 60. As shown in FIG. 61, when the values of the power PW and the duty are obtained as 4×=8 and 6×=10 as a result of test recording at the step S620, these values are substituted into a parameter x of an exponential function ‘y=A*1n(x)+B, where y is the correction amount and x is the recording rate’, A=5.5298 and B=0.0361 are obtained by a least-square method.

If each recording rate is substituted into the parameter x of the resultant ‘y=5.5298*1n(x)+0.0361’, the power and duty values y for each rate can be obtained. In this example, the power and duty values of 8×=12, 12×=14, and 16×=15 are obtained.

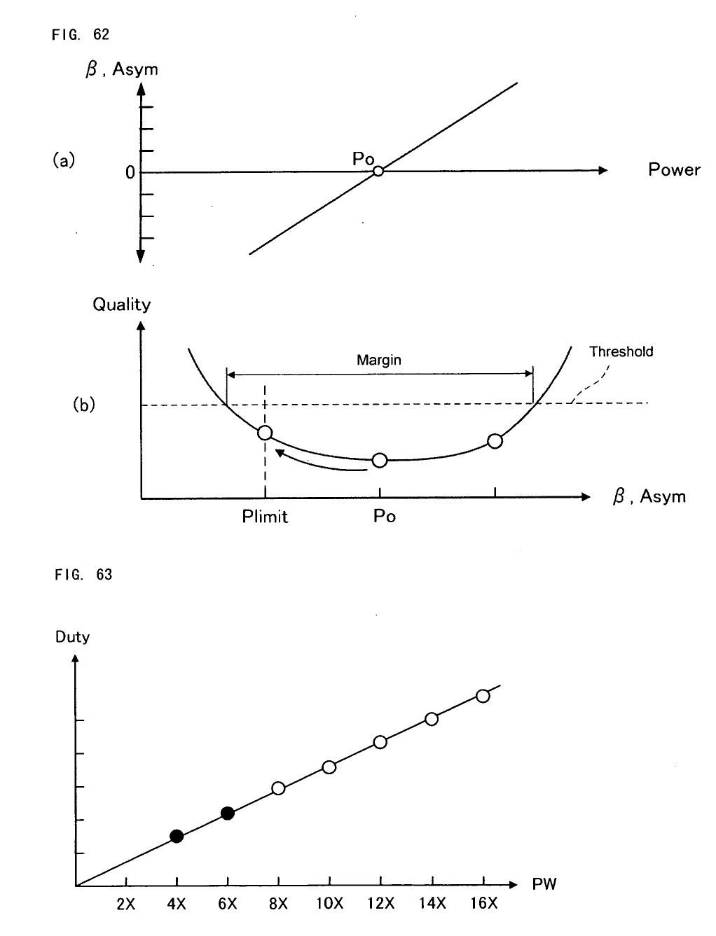

FIGS. 62A and 62B are conceptual diagrams showing the relationship between an upper limit of a recording power and a margin. FIG. 62A shows the relationship between the power and β or asymmetry and FIG. 62B shows the relationship between β or asymmetry and recording quality. Here, the optimum power Po in FIG. 62A or 62B corresponds to the optimum recording power to be predicted by the above-described procedures. Actually, as shown in FIG. 62B, allowable recording quality has some margin amount relative to the optimum power Po. The margin amount can be defined with a region where quality is equal to or less than the threshold, as shown in FIG. 62B.

Accordingly, even when the optimum power Po exceeds the upper limit Plimit of the laser output, the recording power is not immediately reduced to be equal to or less than the upper limit of the laser output at an allowable recording rate. The recording power is reduced to an allowable level within the margin range, thereby expanding the highest recording rate.

The allowable level may be set by directly using the recording power. Preferably, the allowable level is determined by using an index such as β or asymmetry correlated with the recording power. Further, the allowable level may be a previously set value or may be a value derived from the result of test recording to be performed before actual data recording.

FIG. 63 is a conceptual diagram showing the relationship between a recording power and a duty. The energy amount required for recording is increased in proportion to the recording rate. Accordingly, the relationship between the power and the duty is obtained by using the result of test recording at 4× and 6× capable of test recording, and the power and the duty of 8× or more having a difficulty in test recording can be predicted by using the relationship.

For example, test recording at 4× and 6× capable of test recording is performed, and the relationship between the power and the duty indicated by a line in the drawing is obtained by using values indicated by black circles in the drawing. Further, the optimum power for each rate from 8× to 16× having a difficulty in test recording is temporarily set in advance, and the duty for each rate having a difficulty in test recording is obtained by using the relationship between the power and the duty. Therefore, values indicated by white circles in the drawing can be obtained. As a result, the high-speed recording condition having a difficulty in test recording can be suitably predicted from the low-speed recording condition capable of test recording.

Similarly, test recording at 4× and 6× capable of test recording is performed, and the relationship between the power and the duty indicated by a line in the drawing is obtained by using values indicated by black circles in the drawing. Further, the optimum power for each rate from 8× to 16× having a difficulty in test recording is temporarily set in advance, and the power for each rate having a difficulty in test recording is obtained by using the relationship between the power and the duty. Therefore, values indicated by white circles in the drawing can be obtained. As a result, the high-speed recording condition having a difficulty in test recording can be suitably predicted from the low-speed recording condition capable of test recording.

Moreover, the relationship between the power and the duty is preferably obtained as an expression or coefficient. Further, the duty condition for each recording rate may be fixed to the optimum value derived with the recording rate condition capable of test recording or may be changed for each recording rate.

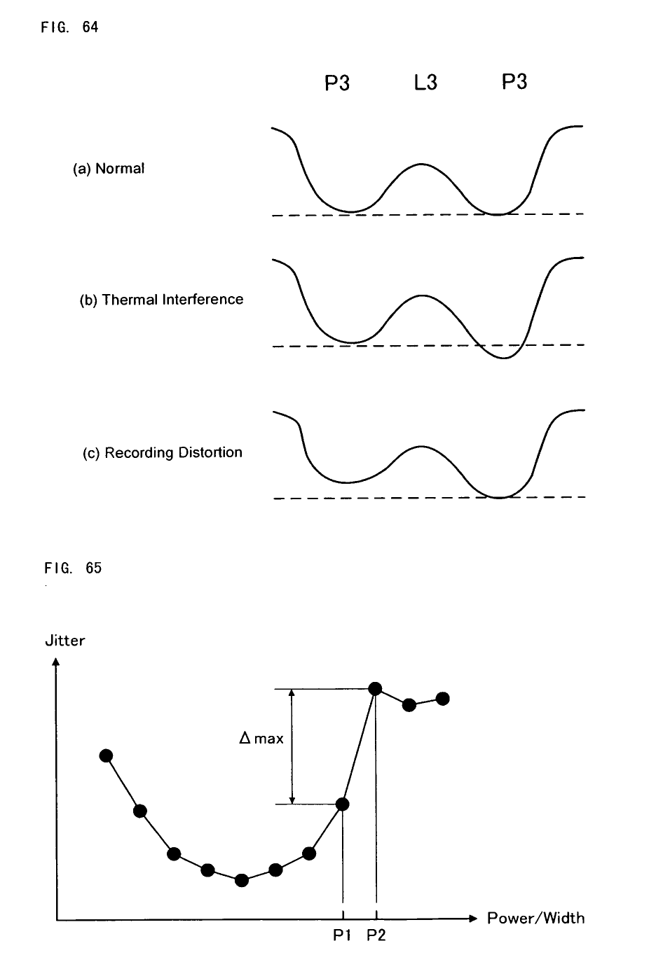

FIG. 64 is a conceptual diagram showing a state of an RF signal when recording distortion is generated. FIG. 64 shows a state of an RF signal obtained by recording a pattern successively having a pit 3T, a land 3T, and a pit 3T and then reproducing the recorded pattern.

As shown in (a), in the obtained RF signal with no thermal interference or recording distortion, the signal levels of the pits on both sides of the land are the same. As shown in (b), however, in the RF signal with thermal interference, heat when the formation of the preceding pit interferes when the formation of the subsequent pit, and the signal level obtained from the subsequent pit is different from that of the normal state.

On the other hand, as shown in (c), in the RF signal having the recording distortion, for example, the signal level obtained from the preceding pit is different from that of the normal state due to an optical influence of a pregroove deformed when the formation of the subsequent pit. The recording distortion has influence on the reproduction of the pits before and after the part having the distortion, and thus it is difficult to specify a generation source or generation condition.

FIG. 65 is a conceptual diagram showing an example of a method for detecting the recording distortion. When detecting the recording distortion, as shown in FIG. 65, an index representing recording quality, for example, a jitter is acquired by test recording which gradually changes the power or the pulse width, and the recording condition under which the change in jitter value is the maximum is specified as a recording distortion generation condition.

For example, as shown in FIG. 65, when the change in jitter between the power P1 and the power P2 shows the maximum change amount Δmax, the recording distortion is generated with the power P1 or the power of P2 or more. Accordingly, by setting the power P1 as the upper limit of the recording condition, recording can be performed with no recording distortion.

As shown in FIG. 65, the estimation parameter such as the jitter or error rate has the optimum point relative to the recording power or the recording pulse width. Then, a margin curve is formed such that recording quality is degraded from the optimum point.

This is because, when recording is performed with the recording power to be higher than the optimum point and the recording pulse width to be longer than the optimum point, the recording state becomes an excessive storage state. When the excessive storage exceeds a predetermined level, the recording distortion occurs.

Accordingly, the excessive storage state can be formed while changing the recording condition, and a part where the degradation tendency of recording quality appears can be detected as the recording distortion generation condition. Specifically, as shown in FIG. 65, recording may be performed while successively changing the recording power or the recording pulse width, a change ratio of a jitter serving as the estimation parameter may be obtained, and a condition having the maximum change ratio may be applied to the recording distortion generation condition.

Moreover, although a detection method uses the jitter as the estimation parameter in the example shown in FIG. 65, an error rate, or length information or amplitude information of one or plural mark data when recorded data is reproduced may be used as the estimation parameter.

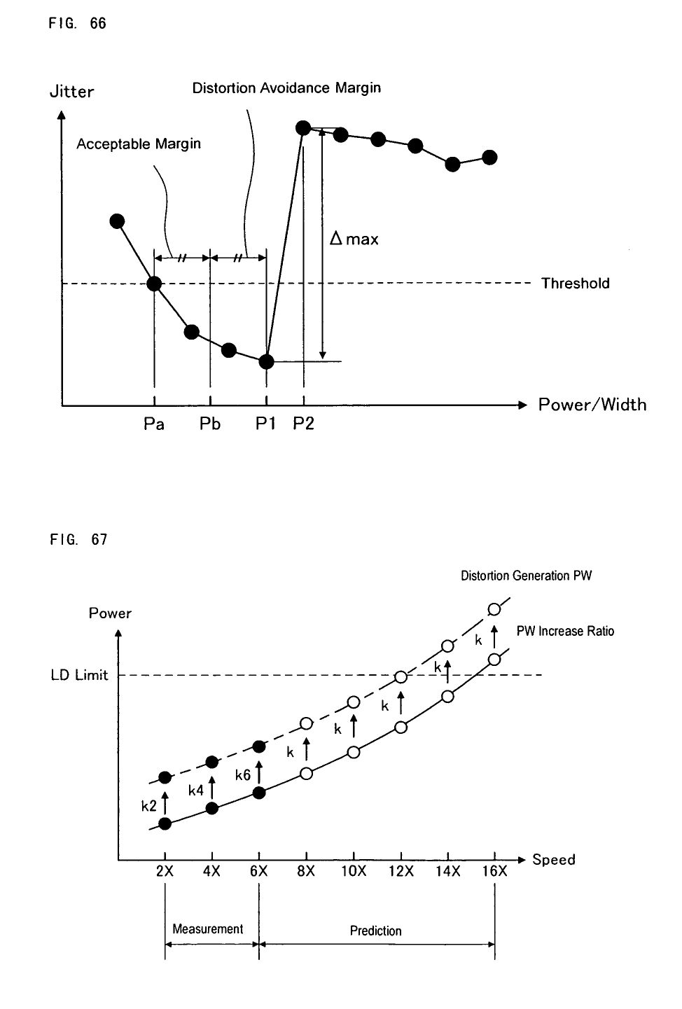

FIG. 66 is a conceptual diagram showing an example of the determination of a recording condition in consideration of the recording distortion. As shown in FIG. 66, when the jitter change between the power P1 and the power P2 is represented by the maximum change amount Δmax, even if the power P1 is the minimum jitter point, in order to reliably avoid the occurrence of the distortion, a power Pa to be a cross point with the jitter threshold and an intermediate power Pb between the power Pa and the power P1 are specified, and a recording condition having the minimum jitter point between Pa and Pb is set as the optimum condition. Incidentally, a power between Pb and P1 is liable to get influence of recording distortion, so that desirably, it is not used in order to reliably avoid the occurrence of the recording distortion.

FIG. 67 is a conceptual diagram showing an example of a method for predicting a condition where recording distortion is generated. In the example shown in FIG. 67, an example of a method for predicting the distortion generation condition at a recording rate different from the test recording condition is described. This method is effective for obtaining the distortion generation condition for high-speed recording having a difficulty in recording with the test region.

For example, when high-speed recording having a difficulty in test recording is assigned to an arbitrary recording medium by a user, as shown in FIG. 67, the distortion generation condition is specified by the above-described method at a recording rate capable of test recording, for example, 2× to 6×, and a distortion characteristic ratio k relative to a predetermined prediction expression is derived by using the specified condition.

For example, based on the result of test recording at 2×, 4×, and 6× indicated by black circles in the drawing, a curve for a power increase ratio from 6× to 16× having a difficulty in test recording is obtained, and the distortion generation conditions of 2×, 4×, and 6× indicated by the same black circles are obtained by test recording. From the relationship between these distortion generation conditions and the curve for a power increase ratio, the distortion characteristic ratios k2, k4, and k6 for individual rest rates are obtained.

Subsequently, the distortion characteristic ratios k2, k4, and k6 are averaged so as to obtain the distortion characteristic ratio k in a high-speed region from 6× to 16×. Further, by multiplying the curve for a power increase ratio by the distortion characteristic ratio k, the distortion generation conditions for individual rates from 6× to 16× are specified.

Moreover, the distortion characteristic ratio k of the high-speed region may be obtained by using only one distortion characteristic ratio in the test region, for example, k6 obtained by test recording of 6×. Although a case for predicting the distortion generation power is described in the example shown in FIG. 67, the prediction of the pulse width can be similarly performed. Further, the power increase ratio represented as the prediction expression may be stored in a drive or a medium in advance.

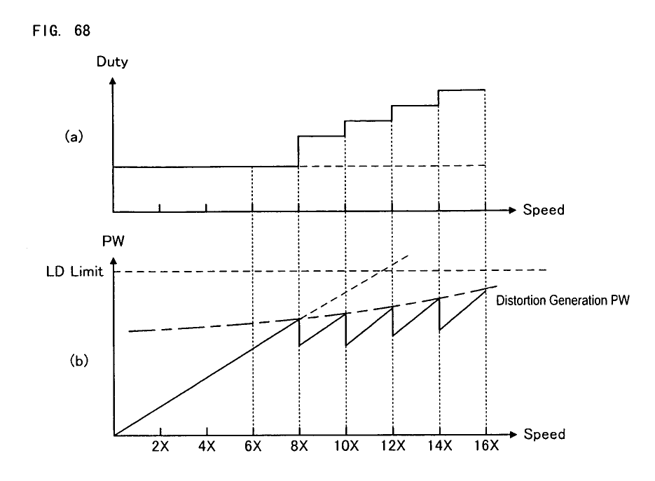

FIGS. 68A and 68B are conceptual diagrams showing a method for determining a recording condition with no distortion. As described above, in order to avoid the recording distortion, recording should be performed with the distortion generation condition obtained by test recording as the upper limit. Therefore, the recording power and the pulse width should be equal to or less than the distortion generation power and pulse width, respectively.

In the method for predicting the optimum condition shown in FIGS. 53A to 54B, the upper limit of the laser output is set as the upper limit of the optimum recording condition. On the other hand, in order to avoid the occurrence of the distortion, as shown in FIGS. 68A and 68B, the distortion generation condition is set as the upper limit.

Specifically, in case that a curve representing the distortion generation power for each rate shown in FIG. 67 is set as the upper limit, and the distortion generation power to be predicted for an arbitrary recording rate exceeds the prediction result of the recording power for the rate, recording is performed while reducing the recording power through the increase in the duty or reducing the recording rate.

More specifically, recording can be performed with no distortion by using the distortion generation power obtained by test recording as the upper limit of the power of the step S504 shown in FIG. 55 and using the distortion generation power obtained by test recording as the upper limit of the duty of the step S508 shown in FIG. 55.

Similarly, recording can be performed with no distortion by using the distortion generation power obtained by test recording as the upper limit of the power of the steps S604 and S608 shown in FIG. 59 and using the distortion generation power obtained by test recording as the upper limit of the duty of the step S612 shown in FIG. 59.

In addition, the optimum power is preferably set to be sufficiently smaller than the distortion generation power in consideration of a variation in laser output or an influence of fresh air. Specifically, the margin of about 0.8 to 0.9 is preferably provided between the optimum recording power and the distortion generation power. Moreover, like the recording power, the optimum condition of the recording pulse width can be determined with no distortion.

According to one embodiment, even in case of a medium unknown to a drive, a recording condition closer to an optimum can be obtained, and thus a closer accommodation to a recording environment is expected.

What is claimed is:

1. An optical information recording apparatus for recording information onto an optical recording medium by irradiating laser light based on a recording pulse, the optical information recording apparatus comprising:
a recording apparatus configured to generate signal distortion in a test region of the medium by test recording onto the medium;
a circuit configured to specify a recording condition with the signal distortion generated; and
a circuit configured to set a condition of the recording pulse with a condition corresponding to the set recording condition as an upper limit.

2. The optical information recording apparatus according to claim 1, further comprising:
a recording apparatus configured to perform test recording onto the medium while gradually changing the condition of the recording pulse;
a recording apparatus configured to acquire recording characteristics obtained by reproducing the result of test recording for every condition gradually changed;
a circuit configured to detect change amounts in recording characteristics according to the change of the condition; and
a circuit configured to specify a maximum value of the detected change amounts and to specify a condition corresponding to the maximum value.

3. An optical information recording apparatus for recording information onto an optical recording medium by irradiating laser light based on a recording pulse, the optical information recording apparatus comprising:
a recording apparatus configured to perform test recording at a first rate in a test region provided on an inner circumference side of the medium;
a circuit for determining a power of the recording pulse at the first rate based on the result of test recording;
a circuit for determining a power of the recording pulse at a second rate higher than the first rate based at least in part on the determined power at the first rate;
a recording apparatus configured to detect signal distortion generated within the test region;
a circuit configured to specify a power with which the detected signal distortion is generated;
a circuit configured to specify a distortion generating power at the second rate based at least in part on the specified distortion generating power; and
a circuit configured to reduce the power of the recording pulse and/or increasing a duty in case that the determined power at the second rate is more than a power corresponding to the distortion generating power at the second rate.

4. The optical information recording apparatus according to claim 3, further comprising:
a circuit configured to reduce a recording rate in case that the power of the recording pulse is higher than the power corresponding to the distortion generating power even when the reduction in power and/or the increase in duty are performed.

5. The optical information recording apparatus according to claim 3, further comprising:
a circuit configured to determine a duty of the recording pulse at the first rate based on the result of test recording;
a circuit configured to determine a duty of the recording pulse at the second rate higher than the first rate based at least in part on the determined duty at the first rate;
a recording apparatus configured to detect the signal distortion generated within the test region;
a circuit configured to specify a duty with which the detected signal distortion is generated;
a circuit configured to specify a distortion generating duty at the second rate based at least in part on the specified distortion generating duty; and
a circuit configured to reduce the power of the recording pulse and/or increasing a duty in case that the determined duty at the second rate is more than a duty corresponding to the distortion generating duty at the second rate.

6. The optical information recording apparatus according to claim 5, further comprising:
a circuit configured to reduce a recording rate in case that the duty of the recording pulse is more than the duty corresponding to the distortion generating duty even when the reduction in power and/or the increase in duty are performed.

7. The optical information recording apparatus according to claim 3, further comprising:
a circuit configured to determine a condition of the recording pulse at the first rate based on the result of test recording;
a circuit configured to determine a condition of the recording pulse at the second rate higher than the first rate based at least in part on the determined condition at the first rate;
a circuit configured to detect the signal distortion generated within the test region;
a circuit configured to specify a condition with which the detected signal distortion is generated;
a circuit configured to obtain the relationship between the specified distortion generation condition and the determined condition at the first rate;
a circuit configured to specify a distortion generation condition at the second rate based at least in part on the obtained relationship; and
a recording apparatus configured to perform recording in a recording region provided on an outer circumference side from the test region at the second rate.

8. The optical information recording apparatus according to claim 7, further comprising:
a circuit configured to specify a distortion generation condition at the second rate based at least in part on the specified distortion generation condition;
a circuit configured to judge whether or not recording can be performed in the recording region provided on the outer circumference side from the test region at the second rate with no distortion, based at least in part on the determined distortion generation condition at the second rate;
a circuit configured to change a recording rate based on the judgment result; and
a circuit configured to report a recording rate after the judgment.

9. The optical information recording apparatus according to claim 7, further comprising:
a circuit configured to specify a distortion generation condition at the second rate based at least in part on the specified distortion generation condition;
a circuit configured to judge whether or not recording can be performed in the recording region provided on the outer circumference side from the test region at the second rate with no distortion, based at least in part on the determined distortion generation condition at the second rate;
a circuit configured to change a recording rate based on the judgment result; and
a circuit configured to store a recording condition after the judgment,
wherein the determination of the recording pulse condition at the second rate is performed based at least in part on the stored recording condition.

10. An optical information recording method for recording information onto an optical recording medium by irradiating laser light based on a recording pulse, the optical information recording method comprising:
generating signal distortion in a test region of the medium by test recording onto the medium;
specifying a recording condition with which the signal distortion is generated; and
setting a condition of the recording pulse with a condition corresponding to the specified recording condition as an upper limit.

11. The optical information recording method according to claim 10, further comprising:
performing test recording onto the medium while gradually changing the condition of the recording pulse;
acquiring recording characteristics obtained by reproducing the result of test recording for every condition gradually changed;
detecting change amounts in recording characteristics according to the change of the condition; and
specifying a maximum value of the detected change amounts and specifying a condition corresponding to the maximum value.

12. An optical information recording method for recording information onto an optical recording medium by irradiating laser light based on a recording pulse, the optical information recording method comprising:
performing test recording at a first rate in a test region provided on an inner circumference side of the medium;
determining a power of the recording pulse at the first rate based on the result of test recording;
determining a power of the recording pulse at a second rate higher than the first rate based at least in part on the determined power at the first rate;
detecting signal distortion generated within the test region;
specifying a power with which the detected signal distortion is generated;
specifying a distortion generating power at the second rate based at least in part on the specified distortion generating power; and
reducing the power of the recording pulse and/or increasing a duty in case that the determined power at the second rate is higher than a power corresponding to the distortion generating power at the second rate.

13. The optical information recording method according to claim 12, further comprising:
determining a duty of the recording pulse at the first rate based on the result of test recording;
determining a duty of the recording pulse at the second rate higher than the first rate based at least in part on the determined duty at the first rate;
detecting the signal distortion generated within the test region;
specifying a duty with which the detected signal distortion is generated;
specifying a distortion generating duty at the second rate based at least in part on the specified distortion generating duty; and
reducing the power of the recording pulse and/or increasing a duty in case that the determined duty at the second rate is more than a duty corresponding to the distortion generating duty at the second rate.

14. The optical information recording method according to claim 12, further comprising:
determining a condition of the recording pulse at the first rate based on the result of test recording;
determining a condition of the recording pulse at the second rate higher than the first rate based at least in part on the determined condition at the first rate;
detecting the signal distortion generated within the test region;
specifying a condition with which the detected signal distortion is generated;
obtaining the relationship between the specified distortion generation condition and the determined condition at the first rate;
specifying a distortion generation condition at the second rate based at least in part on the obtained relationship; and
performing recording in a recording region provided on an outer circumference side from the test region at the second rate.

15. The optical information recording method according to claim 14, further comprising:
specifying a distortion generation condition at the second rate based at least in part on the specified distortion generation condition;
judging whether or not recording can be performed in the recording region provided on the outer circumference side from the test region at the second rate with no distortion, based at least in part on the determined distortion generation condition at the second rate;
changing a recording rate based on the judgment result; and
reporting a recording rate after the judgment.

16. The optical information recording method according to claim 14, further comprising:
specifying a distortion generation condition at the second rate based at least in part on the specified distortion generation condition;
judging whether or not recording can be performed in the recording region provided on the outer circumference side from the test region at the second rate with no distortion, based at least in part on the determined distortion generation condition at the second rate;
changing a recording rate based on the judgment result; and
storing a recording condition after the judgment,
wherein the determination of the recording pulse condition at the second rate is performed based at least in part on the stored recording condition.

17. A signal processing circuit incorporated into an optical information recording apparatus configured to irradiate laser light based on a recording pulse for recording information onto an optical information medium, the circuit being configured to perform the optical information recording method according to claim 10.

18. A signal processing circuit incorporated into an optical information recording apparatus configured to irradiate laser light based on a recording pulse for recording information onto an optical information medium, the circuit being configured to perform the optical information recording method according to claim 11.

19. A signal processing circuit incorporated into an optical information recording apparatus configured to irradiate laser light based on a recording pulse for recording information onto an optical information medium, the circuit being configured to perform the optical information recording method according to claim 12.

20. A signal processing circuit incorporated into an optical information recording apparatus configured to irradiate laser light based on a recording pulse for recording information onto an optical information medium, the circuit being configured to perform the optical information recording method according to claim 13.

21. A signal processing circuit incorporated into an optical information recording apparatus configured to irradiate laser light based on a recording pulse for recording information onto an optical information medium, the circuit being configured to perform the optical information recording method according to claim 14.

22. A signal processing circuit incorporated into an optical information recording apparatus configured to irradiate laser light based on a recording pulse for recording information onto an optical information medium, the circuit being configured to perform the optical information recording method according to claim 15.

23. A signal processing circuit incorporated into an optical information recording apparatus configured to irradiate laser light based on a recording pulse for recording information onto an optical information medium, the circuit being configured to perform the optical information recording method according to claim 16.
